(19) United States
(12) Patent Application Publication
(10) Pub. No.: US 2026/0050633 A1
(43) Pub. Date: Feb. 19, 2026

(54) INFORMATION PROCESSING APPARATUS, INFORMATION PROCESSING METHOD, AND NON-TRANSITORY COMPUTER-READABLE RECORDING MEDIUM

(71) Applicant: LY Corporation, Tokyo (JP)

(72) Inventor: Masajirou IWASAKI, Tokyo (JP)

(21) Appl. No.: 19/204,151

(22) Filed: May 9, 2025

(30) Foreign Application Priority Data
Aug. 14, 2024 (JP) 2024-135211

(51) Int. Cl. G06F 16/901

(52) U.S. Cl. CPC G06F 16/9024

(57) ABSTRACT

An information processing apparatus according to the present application includes an acquisition unit that acquires first graph information indicating a first graph in which a plurality of nodes corresponding to each of a plurality of objects to be searched are connected by edges and condition information indicating a determination condition of a shortcut edge to be deleted in a graph, and a generation unit that generates second information indicating a second graph in which the edge satisfies the determination condition of the shortcut edge is deleted as the shortcut edge from the first graph.

### CROSS-REFERENCE TO RELATED APPLICATIONS

The present application claims priority to and incorporates by reference the entire contents of Japanese Patent Application No. 2024-135211 filed in Japan on Aug. 14, 2024.

### BACKGROUND OF THE INVENTION

### 1. Field of the Invention

The present invention relates to an information processing apparatus, an information processing method, and a non-transitory computer-readable recording medium.

### 2. Description of the Related Art

Conventionally, a technology for searching (searching) for various types of information has been provided. For example, there is provided a technology for generating graph data in which nodes corresponding to a search target are connected by edges in order to perform a search regarding a predetermined target. For example, in Japanese Patent No. 6293335, whether or not an oriented edge connected from one node to another node corresponds to a shortcut edge is determined, and the oriented edge determined as the shortcut edge is deleted, thereby generating graph data in which an increase in the number of edges is suppressed. Furthermore, such a technology is used, for example, for image retrieval.
Patent Literature 2: Japanese Patent No. 7080803
Patent Literature 3: Japanese Patent No. 7130019

However, there is room for improvement in the above-described conventional technology. For example, in the above-described conventional technology, by deleting the shortcut edge, an increase in the number of edges can be suppressed, but there may be a case where the edge is excessively deleted. For example, in the above-described conventional technology, it is difficult to say that the processing procedure and the determination condition are sufficiently considered when performing the shortcut edge deletion processing. Therefore, there is room for improvement in appropriately generating information indicating another graph from which an edge is deleted in the graph.

### SUMMARY OF THE INVENTION

According to one aspect of an embodiment, an information processing apparatus includes an acquisition unit that acquires first graph information indicating a first graph in which a plurality of nodes corresponding to each of a plurality of objects to be searched are connected by edges and condition information indicating a determination condition of a shortcut edge to be deleted in a graph; and a generation unit that sets an oriented edge with a first node as a start point and a second node as an end point among edges included in the first graph as a target edge, and generates second information indicating a second graph in which the target edge is deleted as the shortcut edge in a case where a relationship among each of bypass nodes including at least a third node connected with an oriented edge with the first node as a start point, and a fourth node serving as a start point of an oriented edge with the second node as an end point, the fourth node being a node reachable from the third node, the first node, and the second node satisfies the determination condition of the shortcut edge.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of information processing according to an embodiment;

FIG. 2 is a conceptual diagram illustrating an example of shortcut determination according to the embodiment;

FIG. 3 is a conceptual diagram illustrating an example of shortcut determination according to the embodiment;

FIG. 4 is a conceptual diagram illustrating an example of shortcut determination according to the embodiment;

FIG. 5 is a conceptual diagram illustrating an example of shortcut determination according to the embodiment;

FIG. 6 is a conceptual diagram illustrating an example of shortcut determination according to the embodiment;

FIG. 7 is a diagram illustrating a configuration example of an information processing system according to the embodiment;

FIG. 8 is a diagram illustrating a configuration example of an information processing apparatus according to the embodiment;

FIG. 9 is a diagram illustrating an example of an object information storage unit according to the embodiment;

FIG. 10 is a diagram illustrating an example of a condition information storage unit according to the embodiment;

FIG. 11 is a diagram illustrating an example of a criterion information storage unit according to the embodiment;

FIG. 12 is a diagram illustrating an example of a graph information storage unit according to the embodiment;

FIG. 13 is a flowchart illustrating an example of information processing according to the embodiment;

FIG. 14 is a flowchart illustrating an example of information processing according to the embodiment;

FIG. 15 is a diagram illustrating an example of information for a starting point used for information processing according to the embodiment;

FIG. 16 is a flowchart illustrating an example of search processing using graph data; and

FIG. 17 is a hardware configuration diagram illustrating an example of a computer that implements functions of an information processing apparatus.

### DETAILED DESCRIPTION OF THE PREFERRED EMBODIMENTS

Hereinafter, modes (hereinafter referred to as “embodiment”) for implementing an information processing apparatus, an information processing method, and a non-transitory computer-readable recording medium having stored therein an information processing program according to the present application will be described in detail with reference to the drawings. Note that the information processing apparatus, the information processing method, and the information processing program according to the present application are not limited by the embodiment. In the following embodiments, the same parts are denoted by the same reference numerals, and redundant description will be omitted.

### Embodiment

### 1. Information Processing

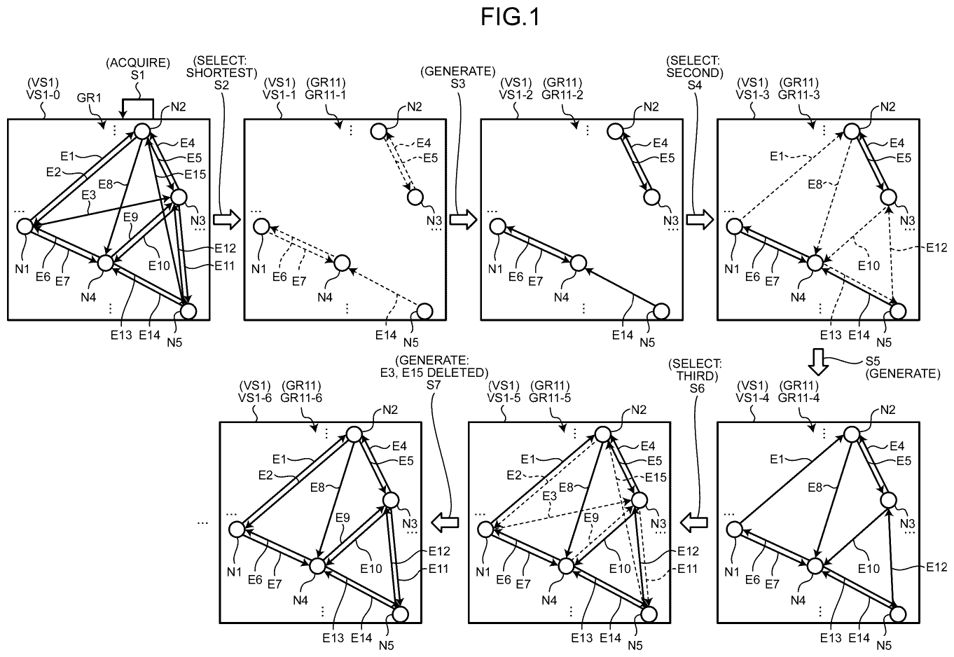

An example of information processing according to an embodiment will be described with reference to FIG. 1. FIG. 1 is a diagram illustrating an example of information processing according to an embodiment. In FIG. 1, information processing apparatus 100 (see FIG. 8) determines whether or not an edge included in a first graph that is graph data (also simply referred to as a “graph”) satisfies a determination condition for a shortcut edge, and generates second information indicating a graph (also referred to as a “second graph”) in which the edge determined to correspond to the shortcut edge is deleted.

Although the second information will be described later in detail, any information can be adopted as the second information as long as the information indicates the second graph. For example, the second information may be information for identifying an edge corresponding to a shortcut edge, such as a flag that is associated with each edge included in the first graph and indicates whether or not the edge is a shortcut edge. Further, the second information may be graph data (graph information) that is generated separately from the first graph and indicates a graph (second graph) after a shortcut edge included in the first graph is deleted. As described above, the second information may be arbitrary information as long as the structure of the graph (second graph) after the shortcut edge deletion included in the first graph can be specified. In the following description, generating the second information indicating the second graph may be referred to as generating the second graph.

FIG. 1 illustrates a case where target information (object) is vectorized, and a graph (graph index) is generated for the vectorized object. That is, FIG. 1 illustrates a case where the information processing apparatus 100 performs processing using a vector as an object value corresponding to an object.

Note that the information used by the information processing apparatus 100 is not limited to a vector, and may be information in any format as long as the information can express similarity of each target. For example, the information processing apparatus 100 may use predetermined data or values corresponding to the respective targets. For example, the information processing apparatus 100 may use a predetermined numerical value (for example, a binary value or a 16 decimal value) generated from each target. For example, the information processing apparatus 100 may use data not limited to a vector, but any form of data as long as a distance (similarity) between data is defined. Furthermore, in the following, a case where the image information is an object will be described as an example, but the object may be various targets such as moving image information and audio information.

Furthermore, in FIG. 1, the information processing apparatus 100 performs information processing on a graph including a node and an oriented edge. Note that the oriented edge here means an edge that can trace data only in one direction. Hereinafter, a source to be traced by an edge, that is, a node serving as a start point is set as a reference source, and a destination to be traced by the edge, that is, a node serving as an end point is set as a reference destination. For example, an oriented edge connected from a predetermined node “A” to a predetermined node “B” indicates an edge whose reference source is the node “A” and whose reference destination is the node “B”.

Hereinafter, the edge having the node “A” as a reference source in this manner is referred to as an output edge of the node “A”. In addition, hereinafter, the edge having the node “B” as a reference source in this manner is referred to as an input edge of the node “B”. That is, the output edge and the input edge referred to herein are differences in which node among two nodes connected by one oriented edge is regarded as the center, and one oriented edge is the output edge and the input edge. That is, the output edge and the input edge are relative concepts, and for one oriented edge, in a case where a node serving as a reference source is regarded as the center, the edge becomes an output edge, and in a case where a node serving as a reference destination is regarded as the center, the edge becomes an input edge. Note that, in the present embodiment, since an oriented edge such as an output edge or an input edge is targeted as an edge, the oriented edge may be simply referred to as an “edge” hereinafter.

Furthermore, each node here corresponds to each object. For example, each of a plurality of local feature amounts extracted from the image may be an object. Furthermore, for example, various data in which the distance between objects is defined may be objects.

For example, the information processing apparatus 100 performs graph generation processing on nodes corresponding to a large amount of image information (for example, millions to hundreds of millions) within a range that can be processed by the information processing apparatus 100, but only a part thereof is illustrated in the drawings. In FIG. 1, in order to simplify the description, an outline of processing will be described by illustrating five nodes. Specifically, in FIG. 1, only nodes N1 to N5 are illustrated, and only some edges such as an edge E1 are also illustrated.

As described above, the description “node N* (* is an arbitrary numerical value)” indicates that the node is a node identified by a node ID “N*”. For example, in a case where “node N1” is described, the node is a node identified by the node ID “N1”.

In addition, in a case where “edge E* (* is an arbitrary numerical value)” is described in this manner, it is indicated that the edge is identified by an edge ID “E*”. For example, in a case where “edge E1” is described, the edge is an edge identified by an edge ID “E1”. For example, it is possible to trace from the node N1 to a node N2 by the edge E1 connected with the node N1 as a reference source and the node N2 as a reference destination. In this case, the edge E1, which is an oriented edge, is an output edge when identified with the node N1 as the center, and is an input edge when identified with the node N2 as the center. In other words, when viewed from the node N1 side, the edge E1, which is an oriented edge, is an edge in which an arrow is pointed from itself to another edge, that is, an outward edge, and when viewed from the node N2 side, the edge E1 is an edge in which an arrow is pointed toward itself, that is, an inward edge. That is, the output edge here can be read as an outward edge, and the input edge can be read as an inward edge.

Furthermore, space information VS1-0 to VS1-6 illustrated in FIG. 1 are diagrams schematically illustrating graphs, and spaces illustrated in the space information VS1-0 to VS1-6 may be the same space. In addition, hereinafter, the space information VS1-0 to VS1-6 will be referred to as space information VS1 when described without particular distinction.

For example, each circle (o) in the space information VS1 of FIG. 1 indicates each node. Each node corresponds to each object. In addition, an arrow line connecting circles (o) in the space information VS1 indicates each oriented edge.

Furthermore, the space information VS1 in FIG. 1 may be a Euclidean space. Furthermore, the space information VS1 illustrated in FIG. 1 is a conceptual diagram for describing a distance between vectors and the like, and the space information VS1 is a multidimensional space. For example, although the space information VS1 illustrated in FIG. 1 is illustrated in a two-dimensional manner in order to be illustrated on a plane, it is assumed that the space information VS1 is a multidimensional space of, for example, 100 dimensions or 1000 dimensions.

In addition, graphs GR11-1 to GR11-6 illustrated in FIG. 1 are diagrams schematically illustrating a process of generating a second graph, and graphs GR11-1 to GR11-6 are the same second graphs generated by information processing. In the following description, the graphs GR11-1 to GR11-6 will be referred to as a graph GR11 when described without particular distinction. For example, in FIG. 1, in a case where the second information is a flag or the like, the information processing apparatus 100 generates information (flag information or the like) for specifying an edge included in the second graph (graph GR11). In addition, in a case where the graph data itself of the second graph is generated, the information processing apparatus 100 generates the graph data of the second graph (graph GR11).

In the present embodiment, the distance of each node in the space information VS1 is set as the similarity between the corresponding objects. For example, it is assumed that the similarity of the target (image information) corresponding to each node is mapped as a distance between nodes in the space information VS1. For example, it is assumed that the similarity between the concepts corresponding to the nodes is mapped to the distance between the nodes. Here, in the example illustrated in FIG. 1, the similarity between objects having a short distance between nodes in the space information VS1 is high, and the similarity between objects having a long distance between nodes in the space information VS1 is low. For example, in the space information VS1 in FIG. 1, the node (node N2) identified by the node ID “N2” and the node (node N3) identified by the node ID “N3” are close to each other, that is, the distance is short. Therefore, it is indicated that the object corresponding to the node identified by the node ID “N2” and the object corresponding to the node identified by the node ID “N3” have high similarity.

Furthermore, for example, in the space information VS1 in FIG. 1, the node identified by the node ID “N1” and the node identified by the node ID “N5” are remote from each other, that is, the distance is long. Therefore, it is indicated that the similarity between the object corresponding to the node identified by the node ID “N1” and the object corresponding to the node identified by the node ID “N5” is low. Note that the distance as an index indicating the similarity may be any distance as long as it is applicable as a distance between vectors (N-dimensional vectors), and for example, various distances such as a Euclidean distance, a Mahalanobis distance, and a cosine distance may be used.

### 1-1. Example of Information Processing

Here, an example of information processing executed by the information processing apparatus 100 will be described with reference to FIG. 1. Specifically, FIG. 1 illustrates an example of generation of the second information indicating the second graph by shortcut edge deletion processing of the information processing apparatus 100. Note that each step illustrated in FIG. 1 is a convenient step for explaining the process of generating the graph, and the actual processing may be performed by processing before that or more detailed processing. Note that the information processing performed by the information processing apparatus 100 may be any processing flow as long as a graph GR11 (second graph) as illustrated in a graph GR11-6 in FIG. 1 is generated.

In FIG. 1, the information processing apparatus 100 acquires the first graph GR1 (step S1). Note that the first graph GR1 illustrated in FIG. 1 is merely an example, and any graph can be adopted as the first graph.

Furthermore, a case where the information processing apparatus 100 acquires the first graph GR1 from a storage unit 120 (see FIG. 8) will be described below as an example, but the information processing apparatus 100 may generate the first graph GR1 or may acquire the first graph GR1 from an external device such as an information providing apparatus 50.

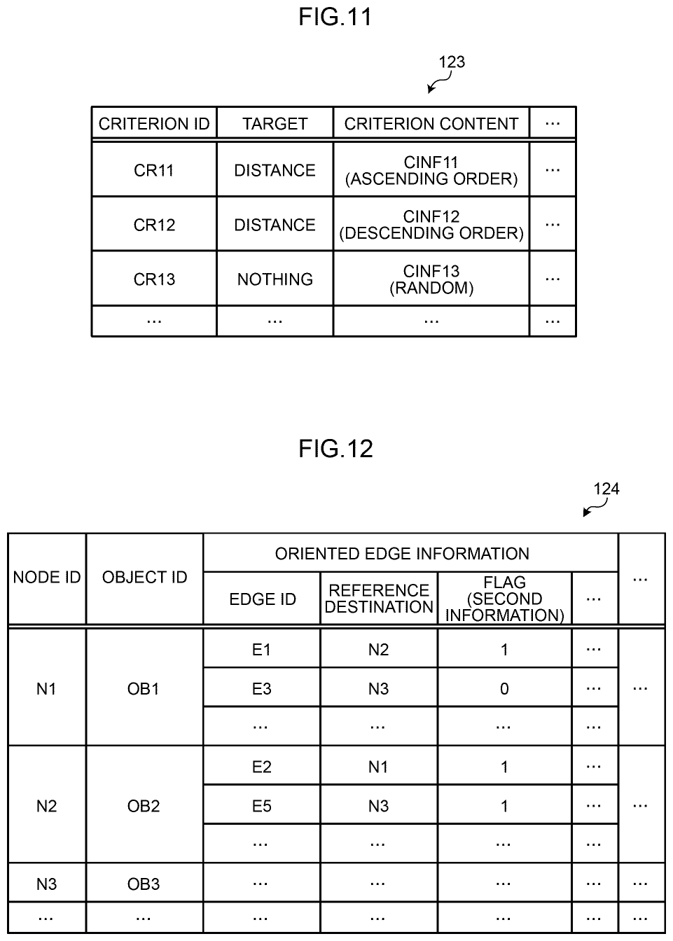

In FIG. 1, a case where a criterion (criterion CR11) identified by a criterion ID “CR11” among criteria stored in a criterion information storage unit 123 (see FIG. 11) is used will be described as an example. For example, the criterion CR11 is a criterion of a selection order (processing order) indicating that an edge is selected as an edge to be processed (also referred to as a “target edge”) in ascending order of edge length.

First, the information processing apparatus 100 selects one unselected oriented edge as a processing target (target edge) among the oriented edges having each of the plurality of nodes included in the first graph GR1 as a start point (start point) as a target edge (step S2). In FIG. 1, since there is no edge processed as the target edge in the first graph GR1 in the space information VS1-0, the information processing apparatus 100 selects the edge having the shortest length as the target edge for each of the nodes N1 to N5.

For example, the information processing apparatus 100 selects the edge E7 having the shortest length among the oriented edges (in FIG. 1, the edges E1, E3, and E7) with the node N1 as the start point in the first graph GR1 as the target edge for the node N1. In addition, the information processing apparatus 100 selects the edge E5 having the shortest length among the oriented edges (in FIG. 1, the edges E2, E5, and E8) with the node N2 as the start point in the first graph GR1 as the target edge for the node N2.

For example, the information processing apparatus 100 selects the edge E4 having the shortest length among the oriented edges (in FIG. 1, the edges E4, E10, and E11) with the node N3 as the start point in the first graph GR1 as the target edge for the node N3. Similarly, the information processing apparatus 100 selects the edge E6, E14 having the shortest length among the oriented edges with the node N4, N5 as the start point in the first graph GR1 as the target edge for each of the nodes N4 and N5. A graph GR11-1 in the space information VS1-2 in FIG. 1 indicates a state in which the information processing apparatus 100 selects the edges E4, E5, E6, E7, and E14 as target edges by indicating the edges E4, E5, E6, E7, and E14 with dotted lines. That is, the graph GR11-1 indicates a state in which it is not determined whether or not to delete any edge in the first graph as a shortcut edge, and no edge is included in the second graph.

The information processing apparatus 100 generates the second information on the basis of the processing for each of the selected target edges (step S3). In FIG. 1, the information processing apparatus 100 generates the second information indicating the graph GR11-2 in the space information VS1-2 on the basis of the processing for each of the selected edges E4, E5, E6, E7, and E14.

Here, since the shortest (shortest) edge cannot be a shortcut, the information processing apparatus 100 determines that the edges E4, E5, E6, E7, and E14 do not correspond to the shortcut edges. Then, the information processing apparatus 100 generates a graph GR11-2 that is the second graph in which the edges E4, E5, E6, E7, and E14 are added (left) without deleting the edges E4, E5, E6, E7, and E14 as the shortcut edges. Note that details of the determination condition as the shortcut edge will be described later.

Next, the information processing apparatus 100 selects one oriented edge unselected as a processing target (target edge) among the oriented edges with each of the plurality of nodes included in the first graph GR1 as a start point (start point) as a target edge (step S4). In FIG. 1, since the shortest edge has already been processed as the target edge for each node in the first graph GR1 in the space information VS1-0, the information processing apparatus 100 selects the edge having the second shortest length as the target edge for each of the nodes N1 to N5.

For example, the information processing apparatus 100 selects the edge E1 having the second shortest length among the oriented edges (in FIG. 1, the edges E1, E3, and E7) with the node N1 as the start point in the first graph GR1 as the target edge for the node N1. In addition, the information processing apparatus 100 selects an edge E8 having the second shortest length among the oriented edges (in FIG. 1, the edges E2, E5, and E8) with the node N2 as the start point in the first graph GR1 as a target edge for the node N2.

For example, the information processing apparatus 100 selects an edge E10 having the second shortest length among the oriented edges (in FIG. 1, the edges E4, E10, and E11) with the node N3 as the start point in the first graph GR1 as the target edge for the node N3. Similarly, the information processing apparatus 100 selects an edge E13, E12 having the second shortest length among the oriented edges with the node N4, N5 as the start point in the first graph GR1 as the target edge for each of the nodes N4, N5.

A graph GR11-3 in the space information VS1-3 in FIG. 1 indicates a state in which the information processing apparatus 100 selects the edges E1, E8, E10, E13, and E12 as target edges by indicating the edges E1, E8, E10, E13, and E12 with dotted lines. That is, the graph GR11-3 indicates a state in which the edges E4, E5, E6, E7, and E14 in the first graph are added to the second graph by the processing in step S3, and the edges E4, E5, E6, E7, and E14 are included in the second graph.

The information processing apparatus 100 generates the second information on the basis of the processing for each of the selected target edges (step S5). In FIG. 1, the information processing apparatus 100 generates the second information indicating the graph GR11-4 in the space information VS1-4 on the basis of the processing for each of the selected edges E1, E8, E10, E13, and E12.

Here, in the graph GR11-2 which is the second graph before execution of step S5, since there is no path bypassing any of the edges E1, E8, E10, E13, and E12 (each target edge does not become a shortcut edge), the information processing apparatus 100 determines that the edges E1, E8, E10, E13, and E12 do not correspond to the shortcut edges. Then, the information processing apparatus 100 generates a graph GR11-4 which is a second graph in which the edges E1, E8, E10, E13, and E12 are added (left) without deleting the edges E1, E8, E10, E13, and E12 as the shortcut edges.

Next, the information processing apparatus 100 selects one oriented edge unselected as a processing target (target edge) among the oriented edges with each of the plurality of nodes included in the first graph GR1 as a start point (start point) as a target edge (step S6). In FIG. 1, since the shortest edge and the second shortest edge have already been processed as the target edge for each node in the first graph GR1 in the space information VS1-0, the information processing apparatus 100 selects an edge having the third shortest length as the target edge for each of the nodes N1 to N5.

For example, the information processing apparatus 100 selects an edge E3 having the third shortest length among the oriented edges (in FIG. 1, the edges E1, E3, and E7) with the node N1 as the start point in the first graph GR1 as the target edge for the node N1. In addition, the information processing apparatus 100 selects the edge E2 having the third shortest length among the oriented edges (in FIG. 1, the edges E2, E5, and E8) with the node N2 as the start point in the first graph GR1 as the target edge for the node N2.

For example, the information processing apparatus 100 selects an edge E11 having the third shortest length among the oriented edges (in FIG. 1, the edges E4, E10, and E11) with the node N3 as the start point in the first graph GR1 as the target edge for the node N3. Similarly, the information processing apparatus 100 selects an edge E9, E15 having the third shortest length among the oriented edges with the node N4, N5 as the start point in the first graph GR1 as the target edge for the node N4, N5.

A graph GR11-5 in the space information VS1-5 in FIG. 1 indicates a state in which the information processing apparatus 100 selects the edges E2, E3, E9, E11, and E15 as target edges by indicating the edges E2, E3, E9, E11, and E15 with dotted lines. That is, the graph GR11-5 indicates a state in which the edges E1, E8, E10, E13, and E12 in the first graph are added to the second graph by the processing in step S5, and the edges E1, E4, E5, E6, E7, E8, E10, E13, E14, and E12 are included in the second graph.

The information processing apparatus 100 generates the second information on the basis of the processing for each of the selected target edges (step S7). In FIG. 1, the information processing apparatus 100 generates the second information indicating the graph GR11-6 in the space information VS1-6 on the basis of the processing for each of the selected edges E2, E3, E9, E11, and E15.

Here, in the graph GR11-4 which is the second graph before execution of step S7, there is a path bypassing the edge E3. In FIG. 1, from the node N1 as the start point of the edge E3 to the node N3, there is a path (route) to be traced from the node N1 to the node N3 other than the edge E3 by tracing from the node N1 to the node N2 by the edge E1 and tracing from the node N2 to the node N3 by the edge E5. In this manner, it is possible to trace from the node N1 to the node N3 via one node N2 without depending on the edge E3. In addition, in the graph GR11-4 which is the second graph before the execution of step S7, tracing can be performed from the node N5 to the node N2 in the order of the edges E12 and E4, that is, by passing through one node N3 without depending on the edge E15, and there is a path bypassing the edge E15.

In a case where there is a path bypassing the target edge as in the above-described edges E3 and E15, the information processing apparatus 100 determines whether or not to delete the target edge as a shortcut edge. The information processing apparatus 100 may determine whether or not there is a path bypassing the target edge by arbitrary processing.

In FIG. 1, for example, the information processing apparatus 100 extracts a node (also referred to as a “bypass node”) having an edge with the node N3 as the output destination (end point) among nodes to which other edges with the node N1, which is the start point of the edge E3, as the start point are input. Since the node N2 is extracted as the bypass node of the edge E3, the information processing apparatus 100 determines that there is a path bypassing the edge E3 and determines whether or not to delete the edge E3 as a shortcut edge.

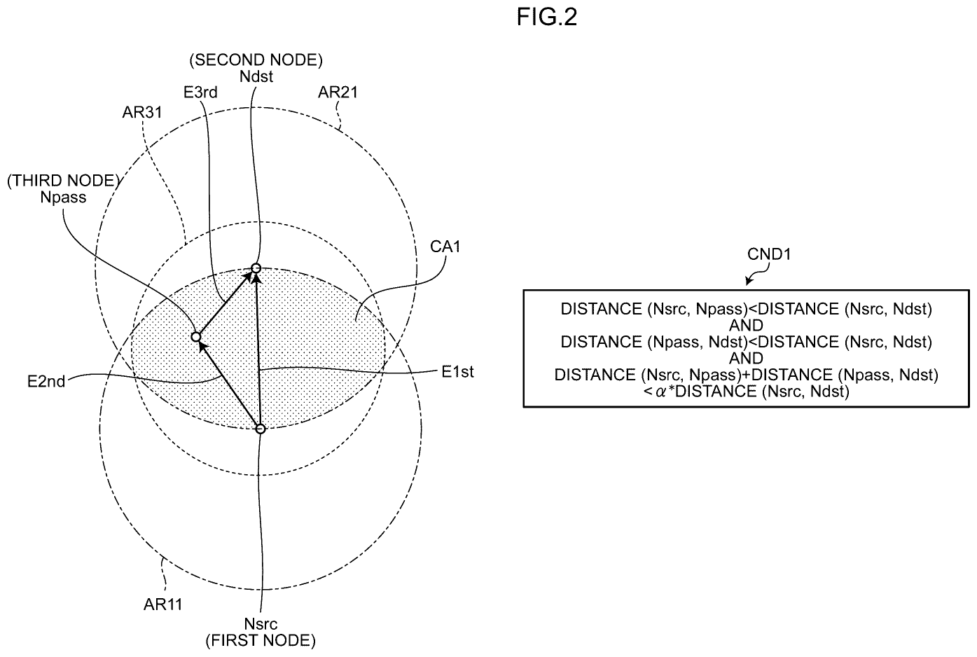

In FIG. 1, a case where a condition (condition CD1) identified by the condition ID “CD1” among the criteria stored in a condition information storage unit 122 (see FIG. 10) is used will be described as an example. For example, the condition CD1 is a condition as illustrated in condition information CND1 in FIG. 2. FIG. 2 is a conceptual diagram illustrating an example of shortcut determination according to the embodiment. Note that the condition is not limited to the condition illustrated in FIG. 2, and an arbitrary condition may be used, but this point will be described later.

First, the outline of the condition CD1 indicated in the condition information CND1 of FIG. 2 will be described using a schematic diagram illustrated on the left side of FIG. 2. In FIG. 2, a node serving as a start point of a target edge (also referred to as a “first node”) will be described as a node Nsrc, a node serving as an end point of the target edge (also referred to as a “second node”) will be described as a node Ndst, and a bypass node (also referred to as a “third node”) on a path bypassing the target edge will be described as a node Npass. In addition, in FIG. 2, a target edge (also referred to as a “first oriented edge”) will be described as an edge E1st, an edge (also referred to as a “second oriented edge”) with the first node as a start point and the third node as an end point will be described as an edge E2nd, and an edge (also referred to as a “third oriented edge”) with the third node as a start point and the second node as an end point will be described as an edge E3rd.

A range AR11 illustrated in FIG. 2 indicates a range whose radius is a distance (also referred to as “first distance”) from the node Nsrc as the first node to the node Ndst as the second node. The distance (first distance) between the node Nsrc and the node Ndst corresponds to the length of the edge E1st which is the first oriented edge.

A condition indicated by “Distance (Nsrc, Npass)<Distance (Nsrc, Ndst)” in the condition information CND1 of FIG. 2 (also referred to as a “first condition”) corresponds to the range AR11. In the first conditions in the condition information CND1 of FIG. 2, “Distance (Nsrc, Npass)” corresponds to a distance (also referred to as “second distance”) between the node Nsrc (first node) and the node Npass which is the third node. The distance (second distance) between the node Nsrc and the node Npass corresponds to the length of the edge E2nd that is the second oriented edge.

In the first condition in the condition information CND1 of FIG. 2, “Distance (Nsrc, Ndst)” corresponds to the distance (first distance) between the node Nsrc (first node) and the node Ndst (second node). That is, when the node Npass (third node) is in the range AR11, it indicates that the target edge (the edge E1st in FIG. 2) satisfies the first condition in the condition information CND1.

A range AR21 illustrated in FIG. 2 indicates a range whose radius is a distance (first distance) from the node Ndst (second node) to the node Nsrc (first node).

A condition indicated by “Distance (Npass, Ndst)<Distance (Nsrc, Ndst)” in the condition information CND1 of FIG. 2 (also referred to as a “second condition”) corresponds to the range AR21. In the second conditions in the condition information CND1 of FIG. 2, “Distance (Npass, Ndst)” corresponds to a distance (also referred to as “third distance”) between the node Npass (third node) and the node Ndst (second node). The distance (third distance) between the node Npass and the node Ndst corresponds to the length of the edge E3rd that is the third oriented edge.

In the second condition in the condition information CND1 of FIG. 2, “Distance (Nsrc, Ndst)” corresponds to the distance (first distance) between the node Nsrc (first node) and the node Ndst (second node). That is, when the node Npass (third node) is in the range AR21, it indicates that the target edge (the edge E1st in FIG. 2) satisfies the second condition in the condition information CND1.

A range AR31 illustrated in FIG. 2 indicates a range obtained by multiplying a range having a diameter between the node Nsrc (first node) and the node Ndst (second node) by a which is a predetermined coefficient. For example, the range AR31 illustrated in FIG. 2 indicates a range obtained by extending the range passing through the node Nsrc and the node Ndst to a times. Note that an arbitrary value can be set as a that is a predetermined coefficient. For example, a may be 1, a value larger than 1 such as 1.1, or a value smaller than 1 such as 0.9.

A condition indicated by “Distance (Nsrc, Npass)+Distance (Npass, Ndst)<α*Distance (Nsrc, Ndst)” in the condition information CND1 of FIG. 2 (also referred to as a “third condition”) corresponds to the range AR21. In the third conditions in the condition information CND1 of FIG. 2, “Distance (Nsrc, Npass)” corresponds to a distance (second distance) between the node Nsrc (first node) and the node Npass which is the third node. In the third conditions in the condition information CND1 of FIG. 2, “Distance (Npass, Ndst)” corresponds to a distance (third distance) between the node Npass (third node) and the node Ndst (second node).

In the third condition in the condition information CND1 of FIG. 2, “α*Distance (Nsrc, Ndst)” is obtained by multiplying the distance (first distance) between the node Nsrc (first node) and the node Ndst (second node) by a, which is a predetermined coefficient. That is, when the node Npass (third node) is in the range AR21, it indicates that the target edge (the edge E1st in FIG. 2) satisfies the third condition in the condition information CND1.

A corresponding range CA1 indicated by hatching in FIG. 2 is a range in which the range AR11, the range AR21, and the range AR31 overlap, and corresponds to a range satisfying the condition CD1 indicated in the condition information CND1. That is, when the node Npass which is the third node is in the corresponding range CA1, it indicates that the target edge (the edge E1st in FIG. 2) satisfies the condition CD1 indicated in the condition information CND1. As described above, the condition CD1 indicated in the condition information CND1 of FIG. 2 is a condition for determining that the target edge corresponds to the shortcut edge when all of the first condition, the second condition, and the third condition are satisfied.

In FIG. 1, the information processing apparatus 100 determines whether or not the above-described condition CD1 is satisfied for the target edge for which it is determined that the bypass path exists. For example, in a case where it is determined that a certain target edge satisfies the above-described condition CD1, the information processing apparatus 100 determines that the target edge corresponds to a shortcut edge. For example, in a case where it is determined that a certain target edge does not satisfy the above-described condition CD1, the information processing apparatus 100 determines that the target edge does not correspond to a shortcut edge. The information processing apparatus 100 deletes the target edge determined to correspond to the shortcut edge as the shortcut edge and generates the second graph.

Here, in FIG. 1, in a case where the node N1 is a first node, the node N3 is a second node, and the node N2 is a third node, the edge E3 is a first oriented edge, the edge E1 is a second oriented edge, and the edge E5 is a third oriented edge. The information processing apparatus 100 determines whether or not to delete the edge E3 as the shortcut edge by using the length of the edge E3 that is the first distance, the length of the edge E1 that is the second distance, the length of the edge E5 that is the third distance, and the determination expression indicated in the condition information CND1. In FIG. 1, since the edge E3 satisfies the determination expression indicated in the condition information CND1, the information processing apparatus 100 determines to delete the edge E3 as a shortcut edge. Similarly, since the edge E15 satisfies the determination expression indicated in the condition information CND1, the information processing apparatus 100 determines to delete the edge E15 as a shortcut edge.

In addition, the information processing apparatus 100 determines that the edges E2, E9, and E11, which are the other target edges, do not correspond to the shortcut edges. For example, the edge E11 traced from the node N3 to the node N5 is an edge (shortcut) having a path (bypass path) from the node N3 to the node N5 traced from the edges E10 and E13, but the information processing apparatus 100 determines not to delete the edge as the shortcut edge. For example, in a case where the edge E11 is processed as the target edge, the information processing apparatus 100 determines not to delete the edge E11 as the shortcut edge since the edge E11 does not satisfy the determination expression indicated in the condition information CND1.

Then, the information processing apparatus 100 generates a graph GR11-6 that is a second graph in which the edges E3 and E15 are deleted as the shortcut edges, and the edges E2, E9, and E11 are added (left) without deleting the edges E2, E9, and E11 as the shortcut edges. Accordingly, in FIG. 1, the information processing apparatus 100 generates a graph GR11 which is a second graph in which the edge E1 is deleted as a shortcut edge from the graph GR1 which is the first graph.

### 1-2. Effects and the Like

As described above, the information processing apparatus 100 generates the second information indicating the second graph in which the target edge determined to be the shortcut edge is deleted from the first graph, thereby appropriately generating the information indicating the other graph in which the edge in the graph is deleted.

For example, when the graph GR1 illustrated in FIG. 1 is processed in order of nodes, the edge E1 may not be deleted as a shortcut edge. For example, when one node is selected in the order of the nodes N1 to N5, all edges with the selected nodes as the start points are processed as target edges, and when the next node is selected, the edge E1 may not be deleted as a shortcut edge. Specifically, in a case where the node N1 is first selected and all the edges E1, E3, and E7 with the selected node N1 as the start point are processed as target edges, the edge E3 is not deleted as a shortcut edge since there is no bypass path of the edge E3 which is the target edge at a stage where the edge E3 is set as the target edge. Then, the edge of the node selected later is more likely to have a bypass path, and the edge of the node selected later is deleted as a shortcut edge, and the structure of the graph may be biased.

On the other hand, as described above, the information processing apparatus 100 selects one edge from each node and performs processing with the edge as a target edge, thereby reducing the possibility that an edge of a specific node is deleted as a shortcut edge and uniformly deleting edges for each node. As a result, the information processing apparatus 100 can generate an appropriate graph.

As described above, the reduction of the shortcut edges differs in the graph generated in that order. In a case where the reduction processing is performed from a long edge in each node, a long edge is deleted as compared with a case where the reduction processing is performed from a short edge. In addition, when the reduction processing is performed on all the edges of the node in units of nodes, the edges are reduced in an initial node of the reduction processing. Therefore, in the example described above, the information processing apparatus 100 performs the reduction processing for the shortest edge of all the nodes, then performs the reduction processing for the second shortest edge of all the nodes, and sequentially repeats this processing. As a result, the information processing apparatus 100 can equalize the number of reduced edges for each node.

In the vector approximation neighborhood search using the graph, it is possible to reduce the edges by deleting the shortcut edges, and it is possible to improve the performance by reducing the edges to be referred at the time of the search. The information processing apparatus 100 can improve the search performance using the generated graph by optimizing the reduction range of the shortcut edge on the basis of the condition as described above. Furthermore, by generating the flag as the second information, the information processing apparatus 100 has the flag indicating the presence or absence of the edge for all the edges, and can perform the deletion processing with one graph by determining (controlling) the presence or absence of the edge with the flag.

### 1-3. Conditions, Criteria, Etc.

In the above example, the condition illustrated in FIG. 2 is used. However, the condition illustrated in FIG. 2 is merely an example of the determination condition for the shortcut edge, and various conditions may be used. An example of this point will be described below. Note that description of the same points as those described above will be omitted as appropriate.

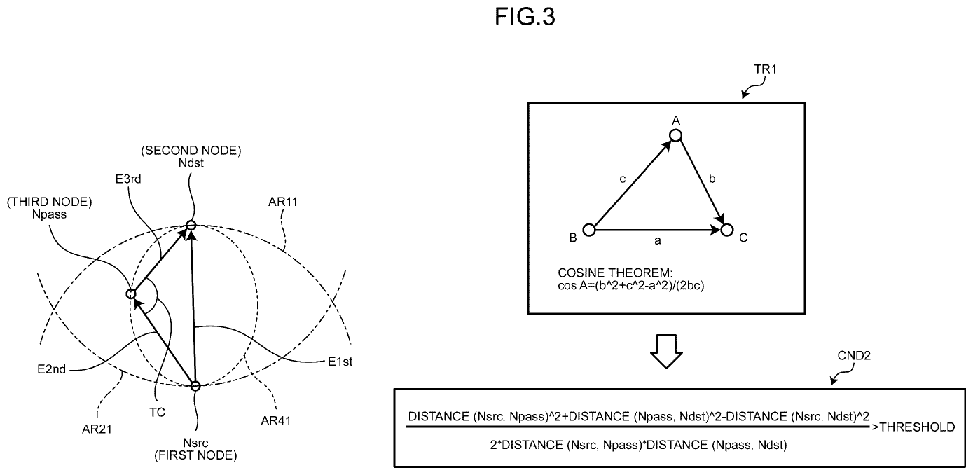

First, the conditions illustrated in FIG. 3 will be described. FIG. 3 is a conceptual diagram illustrating an example of shortcut determination according to the embodiment. Note that description of points similar to those in FIG. 2 will be omitted as appropriate. For example, the node Nsrc, the node Ndst, the node Npass, the edge E1st, the edge E2nd, the edge E3rd, the range AR11, the range AR21, and the like in FIG. 3 are similar to those in FIG. 2, and thus description thereof is omitted.

FIG. 3 illustrates a case where a condition (condition CD2) identified by the condition ID “CD2” among the criteria stored in the condition information storage unit 122 (see FIG. 10) is used. The outline of the condition CD2 illustrated in the condition information CND2 of FIG. 3 will be described using a schematic diagram illustrated on the left side of FIG. 3.

The condition CD2 (also referred to as a “fourth condition”) indicated in the condition information CND2 of FIG. 3 is a condition using a determination expression based on comparison between a value (also referred to as a “calculated value”) calculated using the cosine theorem TR1 and a threshold. FIG. 3 illustrates a case where the condition is satisfied when the calculated value calculated using the cosine theorem TR1 is larger than the threshold. Note that an arbitrary value can be set as the threshold. For example, an arbitrary value can be set as the threshold within a range of possible values of the calculated value calculated using the cosine theorem TR1.

The “Distance (Nsrc, Ndst)” in the condition information CND2 of FIG. 3 corresponds to a distance (first distance) between the node Nsrc (first node) and the node Ndst (second node). The distance (first distance) between the node Nsrc and the node Ndst corresponds to the length of the edge E1st which is the first oriented edge.

The “Distance (Nsrc, Npass)” in the condition information CND2 of FIG. 3 corresponds to a distance (second distance) between the node Nsrc (first node) and the node Npass (third node). The distance (second distance) between the node Nsrc and the node Npass corresponds to the length of the edge E2nd that is the second oriented edge.

The “Distance (Npass, Ndst)” in the condition information CND2 of FIG. 3 corresponds to a distance (third distance) between the node Npass (third node) and the node Ndst (second node). The distance (third distance) between the node Npass and the node Ndst corresponds to the length of the edge E3rd that is the third oriented edge.

For example, the information processing apparatus 100 uses the cosine theorem TR1 to calculate, as a calculated value, a cosine value of an angle formed by a second oriented edge (edge E2nd) corresponding to the second distance and a third oriented edge (edge E3rd) corresponding to the third distance. In FIG. 3, the information processing apparatus 100 calculates a cosine value (cosine value) of a target angle TC in FIG. 3 by using a first distance between the node Nsrc and the node Ndst, a second distance between the node Nsrc and the node Npass, and a third distance between the node Npass and the node Ndst.

A range AR41 illustrated in FIG. 3 corresponds to a range satisfying the condition CD2 indicated in the condition information CND2. That is, when the node Npass which is the third node is in the range AR41, it indicates that the target edge (the edge E1st in FIG. 3) satisfies the condition CD2 indicated in the condition information CND2.

Note that, although FIG. 3 illustrates a case where the range AR41 is included in the range AR11, a part of the range AR41 may overlap the range AR11, and the range other than the part may not overlap the range AR11. Furthermore, FIG. 3 illustrates a case where the range AR41 is included in the range AR21, but a part of the range AR41 may overlap the range AR21, and the range other than the part may not overlap the range AR21.

In FIG. 1, the information processing apparatus 100 determines whether or not the above-described condition CD2 is satisfied for the target edge for which it is determined that the bypass path exists. For example, in a case where it is determined that a certain target edge satisfies the above-described condition CD2, the information processing apparatus 100 determines that the target edge corresponds to a shortcut edge. For example, in a case where it is determined that a certain target edge does not satisfy the above-described condition CD2, the information processing apparatus 100 determines that the target edge does not correspond to a shortcut edge. The information processing apparatus 100 deletes the target edge determined to correspond to the shortcut edge as the shortcut edge and generates the second graph.

Note that the conditions illustrated in FIGS. 2 and 3 are merely examples, and the information processing apparatus 100 may use arbitrary conditions. For example, the information processing apparatus 100 may set a condition that the range AR11, the range AR21, and the range AR41 (fourth condition) satisfy an overlapping range. That is, in the example of FIG. 1, the information processing apparatus 100 may set the third condition (range AR31) among the conditions CD1 indicated in the condition information CND1 of FIG. 2 as the fourth condition (range AR41 illustrated in FIG. 3).

In this manner, the information processing apparatus 100 may set, as a condition for determining that the target edge corresponds to the shortcut edge, that all three of the first condition, the second condition, and the fourth condition are satisfied. Note that the processing is similar to the processing described in FIG. 1 except that the conditions are different, and thus detailed description is omitted.

As described above, the information processing apparatus 100 can appropriately determine the shortcut edge by determining whether or not the target edge corresponds to the shortcut edge on the basis of the relationship among the three edges, that is, the first oriented edge, the second oriented edge, and the third oriented edge, which are the target edges. Furthermore, the information processing apparatus 100 can make a flexible determination and can appropriately determine the shortcut edge by determining whether or not the target edge corresponds to the shortcut edge by combining a plurality of conditions. Then, the information processing apparatus 100 generates a graph in which the shortcut edge is deleted on the basis of the determination of the shortcut edge. As a result, the information processing apparatus 100 can appropriately generate information indicating another graph from which an edge in the graph has been deleted.

### 1-4. Other Condition Examples

Note that, in the above-described example, the deletion of the shortcut edge in a case where there is one bypass node is taken as an example, but the information processing apparatus 100 may perform the shortcut edge deletion processing not only in a case where there is one bypass node but also in a case where there are two or more bypass nodes. That is, the information processing apparatus 100 may determine whether or not the target edge corresponds to the shortcut edge by using the determination condition for the shortcut edge not only in the above-described condition but also in a case where there are two or more bypass nodes. An example of this point will be described below. Note that description of the same points as those described above will be omitted as appropriate.

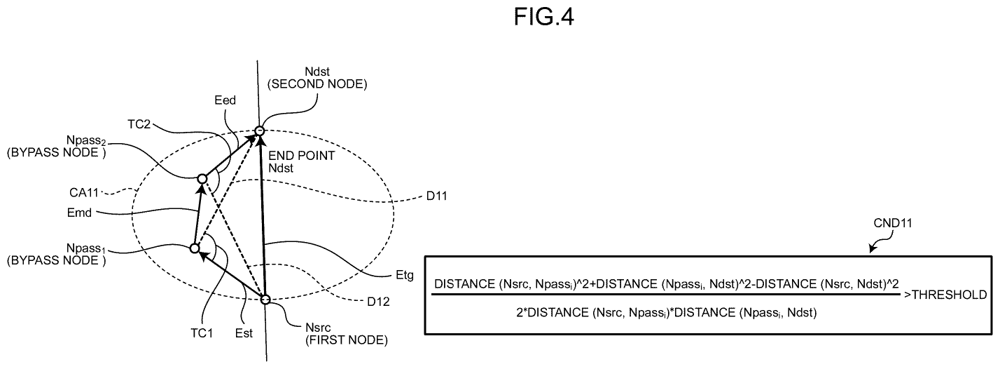

First, the conditions illustrated in FIG. 4 will be described. FIG. 4 is a conceptual diagram illustrating an example of shortcut determination according to the embodiment. Note that description of points similar to those in FIGS. 2 and 3, and the like will be omitted as appropriate. For example, FIG. 4 is similar to that in FIG. 3 except that a bypass node between the node Nsrc as the first node and the node Ndst as the second node is changed from one node Npass to two nodes Npass₁ and Npass₂, and thus description thereof is omitted. As described above, in FIG. 4, a case where the edge Etg which is the oriented edge from the node Nsrc to the node Ndst is the target edge will be described as an example. Hereinafter, when the nodes Npass₁, Npass₂, and the like are described without distinction, they are collectively referred to as a node Npass or a bypass node.

FIG. 4 illustrates a case where the condition information CND11 is used. For example, the condition information CND11 corresponds to a condition obtained by extending the condition information CND2 illustrated in FIG. 3 to a case where there are two or more bypass nodes. For example, the condition corresponding to the condition information CND11 is stored in the condition information storage unit 122 (see FIG. 10). Hereinafter, an outline of the condition indicated in the condition information CND11 of FIG. 4 will be described using a schematic diagram illustrated on the left side of FIG. 4.

A condition (also referred to as a “fifth condition”) indicated in the condition information CND11 of FIG. 4 is a condition using a determination expression based on comparison between a calculated value calculated for each bypass node and a threshold using the cosine theorem TR1 illustrated in FIG. 3. FIG. 4 illustrates a case where the condition is satisfied when each of the calculated values calculated for each bypass node using the cosine theorem TR1 is larger than the threshold. Note that the condition information CND11 is similar to the condition information CND2 except that a plurality of calculated values are used for determination, and thus detailed description thereof is appropriately omitted. For example, in the example of FIG. 4, a natural number (1, 2) up to the number “2” of bypass nodes is assigned to “i” in the condition information CND11, and the information processing apparatus 100 determines that the condition is satisfied in a case where both the calculated values of i=1 and i=2 are larger than the threshold.

“Distance (Nsrc, Ndst)” in the condition information CND11 of FIG. 4 corresponds to a distance (first distance) between the node Nsrc (first node) and the node Ndst (second node). The distance between the node Nsrc and the node Ndst corresponds to the length of the edge Etg that is the target edge.

“Distance (Nsrc, Npassᵢ)” in the condition information CND11 of FIG. 4 corresponds to a distance between the node Nsrc (first node) and the node Npassᵢ (bypass node). For example, when i=1, a distance between the node Nsrc and the node Npass₁ corresponds to the length of the edge Est. For example, when i=2, a distance between the node Nsrc and the node Npass₂ is a distance D12 as indicated by a dotted line in FIG. 4.

A “Distance (Npassi, Ndst)” in the condition information CND11 of FIG. 4 corresponds to a distance between the node Npassi (bypass node) and the node Ndst (second node). For example, when i=1, a distance between the node Npass₁ and the node Ndst is a distance D11 as indicated by a dotted line in FIG. 4. For example, when i=2, a distance between the node Npass₂ and the node Ndst corresponds to a length of an edge Eed that is an oriented edge from the node Npass₂ to the node Ndst.

For example, the information processing apparatus 100 uses the cosine theorem TR1 to calculate a cosine value of an angle formed by a side between the first node and the bypass node and a side between the second node and the bypass node as a calculated value. For example, the information processing apparatus 100 uses the distance between the node Nsrc and the node Ndst, the distance between the node Nsrc and the node Npass₁, and the distance between the node Npass₁ and the node Ndst to calculate the cosine value (cosine value) of a target angle TC1 in FIG. 4 as a calculated value corresponding to the node Npass₁. Furthermore, for example, the information processing apparatus 100 uses the distance between the node Nsrc and the node Ndst, the distance between the node Nsrc and the node Npass₂, and the distance between the node Npass₂ and the node Ndst to calculate a cosine value (cosine value) of a target angle TC2 in FIG. 4 as a calculated value corresponding to the node Npass₂.

The information processing apparatus 100 determines whether or not both the calculated value corresponding to the node Npass₁ and the calculated value corresponding to the node Npass₂ are larger than a threshold. For example, in a case where both the calculated value corresponding to the node Npass₁ and the calculated value corresponding to the node Npass₂ are larger than the threshold, the information processing apparatus 100 determines that the edge Etg satisfies the determination condition for the shortcut edge, and deletes the edge Etg as the shortcut edge.

A range CA11 illustrated in FIG. 4 is a deletion region. For example, the range CA11 is a region that satisfies the condition indicated in the condition information CND11. For example, when the node Npass₁ and the node Npass₂, which are bypass nodes, are in the range CA11, it indicates that the target edge (the edge Etg in FIG. 4) satisfies the condition indicated in the condition information CND11.

For example, the information processing apparatus 100 determines whether or not the above-described condition is satisfied for the target edge for which it is determined that the bypass path exists. For example, in a case where it is determined that a certain target edge satisfies the above-described condition, the information processing apparatus 100 determines that the target edge corresponds to a shortcut edge. For example, in a case where it is determined that a certain target edge does not satisfy the above-described condition, the information processing apparatus 100 determines that the target edge does not correspond to a shortcut edge. The information processing apparatus 100 deletes the target edge determined to correspond to the shortcut edge as the shortcut edge and generates the second graph.

In FIG. 4, the case where the number of bypass nodes is two has been described as an example, but the number of bypass nodes is not limited to two and may be three or more. For example, an upper limit value (for example, 2, 3, 10, and the like) may be set for the number of bypass nodes. For example, the information processing apparatus 100 determines that there is a bypass path from the first node to the second node in a case where the node (second node) that is the end point of the target edge can be reached via nodes up to the upper limit value from the node (first node) that is the start point of the target edge. Note that, here, that another node can be reached from one node means that, for example, another node can be reached by tracing at least one or more edges from one node. For example, in a case where the upper limit value is 2 and the second node can be reached from the first node via two nodes, that is, via three edges, the information processing apparatus 100 determines that there is a bypass path from the first node to the second node.

In FIG. 4, the information processing apparatus 100 determines whether or not there is a bypass path for an edge Etg which is an oriented edge from the node Nsrc to the node Ndst. For example, the information processing apparatus 100 determines that since it is possible to reach the node Ndst from the node Nsrc by passing through two bypass nodes of the nodes Npass₁ and Npass₂, there is a bypass path. For example, the information processing apparatus 100 determines that there is a bypass path from the node Nsrc to the node Ndst by three edges of an edge Est that is an oriented edge from the node Nsrc to the node Npass₁, an edge Emd that is an oriented edge from the node Npass₁ to the node Npass₂, and an edge Eed that is an oriented edge from the node Npass₂ to the node Ndst.

As described above, for the target edge, the information processing apparatus 100 determines whether or not the target edge corresponds to the shortcut edge on the basis of the relationship among the first node, the second node, and each of the plurality of bypass nodes, thereby appropriately determining the shortcut edge even in a case where there are a plurality of bypass nodes. Then, the information processing apparatus 100 generates a graph in which the shortcut edge is deleted on the basis of the determination of the shortcut edge. As described above, in a case where the nodes (bypass nodes) on all the bypass paths satisfy the condition indicated in the condition information CND11, the information processing apparatus 100 generates a graph in which the target edge is deleted as a shortcut edge. As a result, the information processing apparatus 100 can appropriately generate information indicating another graph from which an edge in the graph has been deleted.

As described above, in a case where all the nodes (bypass nodes) on the bypass path belong to the deletion region, the information processing apparatus 100 deletes the shortcut edge. For example, the reduction region is a region (range) corresponding to a case where an angle formed by a node (bypass node) on the bypass path, a start point (for example, a first node), and an end point (for example, a second node) is larger than a specified angle. Note that the number of nodes (bypass nodes) on the bypass path, that is, the above-described upper limit value may be limited to two or three. As a result, the information processing apparatus 100 can suppress an increase in the search cost for the bypass path as the number of nodes (bypass nodes) on the bypass path increases.

Furthermore, in a case where there are two or more bypass nodes, the information processing apparatus 100 may use various conditions other than the above. For example, the information processing apparatus 100 may use various conditions in addition to the condition (fifth condition) indicated in the condition information CND11 in FIG. 4. An example of this point will be described below. For example, the information processing apparatus 100 may use a condition that the distance between the start point (first node) and the passing point (bypass node) needs to be increased in accordance with the passing order. Furthermore, for example, the information processing apparatus 100 may use a condition that each passing point (bypass node) also needs to be within a region similar to the deletion region. Note that description of the same points as those described above will be omitted as appropriate.

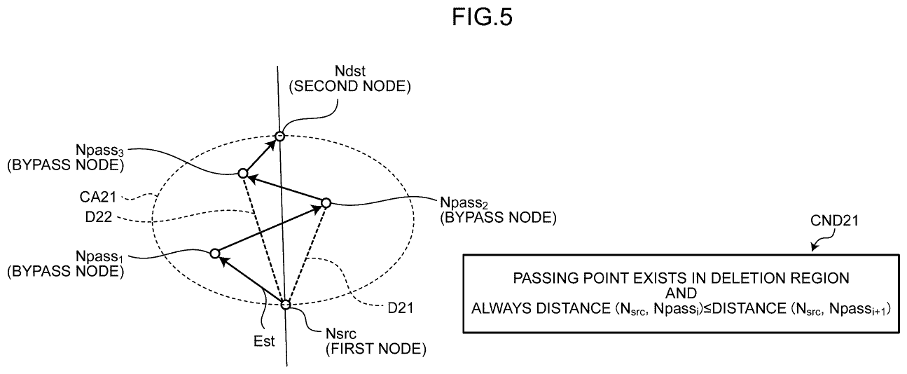

First, the conditions illustrated in FIG. 5 will be described. FIG. 5 is a conceptual diagram illustrating an example of shortcut determination according to the embodiment. Note that description of points similar to those in FIG. 4 and the like will be omitted as appropriate. For example, FIG. 5 is similar to FIG. 4 except that there are three bypass nodes of the node Npass₁, the node Npass₂, and the node Npass₃ between the node Nsrc as the first node and the node Ndst as the second node, and thus description thereof is omitted. Note that, in FIG. 5, illustration of the edge Etg which is an oriented edge from the node Nsrc to the node Ndst is omitted, but a case where the edge Etg is a target edge will be described as an example.

FIG. 5 illustrates a case where the condition information CND21 is used. For example, the condition information CND21 is a condition including a condition that a passing point exists in the deletion region (referred to as a “partial condition #11”) and a condition that the distance (Nsrc, Npassᵢ)≤the distance (Nsrc, Npassᵢ₊₁) is always satisfied (referred to as a “partial condition #12”).

In FIG. 5, the partial condition #11 is a condition satisfied when all of the node Npass₁, the node Npass₂, and the node Npass₃, which are bypass nodes, are located within the range CA21. For example, a range CA21 in FIG. 5 indicates a deletion region and corresponds to the range CA11 illustrated in FIG. 4.

In FIG. 5, the partial condition #12 is a condition that is satisfied when the distance between the node Nsrc and the node Npass₂ is greater than or equal to the distance between the node Nsrc and the node Npass₁ and less than or equal to the distance between the node Nsrc and the node Npass₃. For example, the partial condition #12 is set on the condition that the distance between the first node and each of the bypass nodes is not shortened even via the nodes.

For example, the condition corresponding to the condition information CND21 is stored in the condition information storage unit 122 (see FIG. 10). Hereinafter, an outline of the condition indicated in the condition information CND21 of FIG. 5 will be described using a schematic diagram illustrated on the left side of FIG. 5.

In FIG. 5, the distance between the node Nsrc and the node Npass₁ corresponds to a length of the edge Est and is shorter than a distance D21 that is a distance between the node Nsrc and the node Npass₂. In addition, the distance D21 between the node Nsrc and the node Npass₂ is shorter than a distance D22 which is a distance between the node Nsrc and the node Npass₃. Therefore, the information processing apparatus 100 determines that the partial condition #12 is satisfied. In addition, in FIG. 5, since all of the node Npass₁, the node Npass₂, and the node Npass₃, which are bypass nodes, are located within the range CA21, the information processing apparatus 100 determines that the partial condition #11 is satisfied.

In this case, the information processing apparatus 100 determines that the condition corresponding to the condition information CND21 including the partial condition #11 and the partial condition #12 is satisfied and the edge Etg satisfies the determination condition for the shortcut edge, and deletes the edge Etg as the shortcut edge.

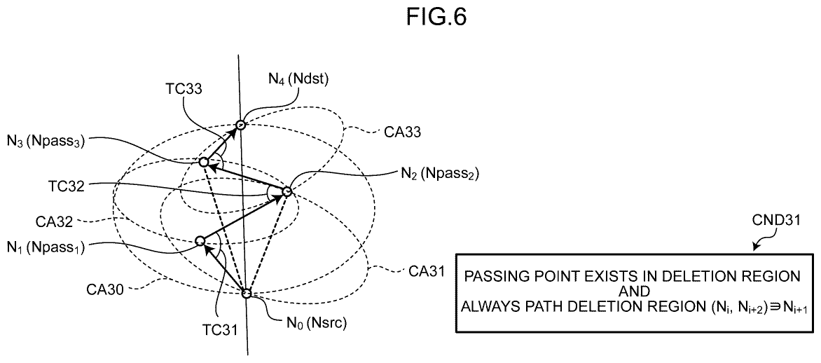

Next, the conditions illustrated in FIG. 6 will be described. FIG. 6 is a conceptual diagram illustrating an example of shortcut determination according to the embodiment. Note that description of points similar to those in FIGS. 4 and, 5, and the like will be omitted as appropriate. Note that, in FIG. 6, in order to provide serial numbers corresponding to conditions, the node Nsrc, the node Npass₁, the node Npass₂, the node Npass₃, and the node Ndst will be described with reference signs of the nodes N₀ to N₄ in order from the subscript number 0. In addition, in FIG. 6, although illustration of the edge Etg which is an oriented edge from the node Nsrc to the node Ndst is omitted, a case where the edge Etg is a target edge will be described as an example.

FIG. 6 illustrates a case where condition information CND31 is used. For example, the condition information CND31 is a condition including a condition that a passing point exists in the deletion region (referred to as a “partial condition #21”) and a condition that the path is always in the deletion region (Ni, Ni+2)∃Ni+1 (referred to as a “partial condition #22”).

In FIG. 6, the partial condition #21 is a condition satisfied when all of the node Npass₁, the node Npass₂, and the node Npass₃, which are bypass nodes, are located within the range CA30. For example, the range CA30 in FIG. 6 indicates a deletion region and corresponds to the range CA21 illustrated in FIG. 5. In FIG. 6, the partial condition #22 is a condition satisfied when all three of following cases #1 to #3 are satisfied.

Case #1: A node Npass₁, which is a bypass node denoted by reference numeral “N₁”, is located in a range CA31, which is a deletion region of a path defined by a node Nsrc, which is a first node denoted by reference numeral “N₀”, and a node Npass₂, which is a bypass node denoted by reference numeral “N₂”.

Case #2: A node Npass₂, which is a bypass node denoted by reference numeral “N₂”, is located in a range CA32, which is a path deletion region defined by a node Npass₁, which is a bypass node denoted by reference numeral “N₁”, and a node Npass₃, which is a bypass node denoted by reference numeral “N₃”.

Case #3: A node Npass₃, which is a bypass node denoted by reference numeral “N₃”, is located in a range CA33, which is a path deletion region defined by a node Npass₂, which is a bypass node denoted by reference numeral “N₂”, and a node Ndst, which is a second node denoted by reference numeral “N₄”.

For example, the range CA31 in FIG. 6 corresponds to a path deletion region defined by the node Nsrc and the node Npass₂. Note that the range CA31 may be an arbitrary region as long as it is defined by the node Nsrc and the node Npass₂. For example, the range CA32 in FIG. 6 corresponds to a path deletion region defined by the node Npass₁ and the node Npass₃. Note that the range CA32 may be an arbitrary region as long as it is defined by the node Npass₁ and the node Npass₃. For example, the range CA33 in FIG. 6 corresponds to a path deletion region defined by the node Npass₂ and the node Ndst. Note that the range CA33 may be an arbitrary region as long as it is defined by the node Npass₂ and the node Ndst.

For example, the ranges CA31 to CA33 may be regions defined similarly to the range AR41 in FIG. 3. For example, the deletion regions such as the ranges CA31 to CA33 may be determined on the basis of a predetermined value a such as an angle similarly to the regions such as the range AR41 in FIG. 3. Note that the values a used for determining the respective deletion regions may be the same value or may be different. For example, each of the ranges CA31 to CA33 may be determined using the values of the target angles TC31, TC32, and TC33 in FIG. 6. As described above, the values a used for defining the deletion regions of the respective paths may be a common value or may be different values. For example, when different values are used as the values a used to define the deletion regions of the respective paths, the values of the respective target angles TC31, TC32, and TC33 in FIG. 6 may be used. Note that the above is merely an example, and the ranges CA31 to CA33 may be defined on the basis of various information. For example, the ranges CA31 to CA33 may be regions defined similarly to the corresponding range CA1 in FIG. 2.

For example, the condition corresponding to the condition information CND31 is stored in the condition information storage unit 122 (see FIG. 10). Hereinafter, an outline of the condition indicated in the condition information CND31 of FIG. 6 will be described using a schematic diagram illustrated on the left side of FIG. 6.

In FIG. 6, the information processing apparatus 100 determines that the partial condition #21 and the partial condition #22 are satisfied. Then, the information processing apparatus 100 determines that the condition corresponding to the condition information CND31 including the partial condition #21 and the partial condition #22 is satisfied and the edge Etg satisfies the determination condition for the shortcut edge, and deletes the edge Etg as the shortcut edge.

Note that, in the above example, the target edge is selected in ascending order of distance, but this is merely an example of the above criteria, and various criteria may be used. An example of this point will be described below.

For example, the information processing apparatus 100 may select the target edge in descending order of distance. In this case, the information processing apparatus 100 sets each of the nodes included in the first graph as a start point, selects the longest oriented edge among the unselected oriented edges as processing targets, and executes the shortcut edge deletion processing.

Furthermore, for example, the information processing apparatus 100 may select the target edge on the basis of a criterion other than the distance. In this case, the information processing apparatus 100 may set each of the nodes included in the first graph as a start point, randomly select an oriented edge from among unselected oriented edges to be processed, and execute the shortcut edge deletion processing.

Note that, in a case of generating the first graph, the information processing apparatus 100 may generate a k-nearest neighbor graph as the first graph or may generate an approximate k-nearest neighbor graph as the first graph. For example, the k-nearest neighbor graph is a graph in which for each node, edges to k nodes are connected in the order of near distance from the node. For example, the approximate k-nearest neighbor graph is a concept including a graph based on a graph (also referred to as “ANNG”) approximate to a k-nearest neighbor graph generated by performing k-nearest neighbor search using a graph being generated at the time of generating a graph index (graph). Note that the approximate k-nearest neighbor graph generated by the processing as described above may be a k-nearest neighbor graph. That is, the approximate k-nearest neighbor graph is a concept including a k-nearest neighbor graph. In addition, any processing as disclosed in Japanese Patent No. 6293335, Masajiro Iwasaki “Proximity Search using Approximate K Nearest Neighbor Graph with a Tree Structured Index”, Journal of Information Processing Society of Japan, 2011/2, Vol. 52, No. 2. pp. 817-828, or the like can be employed for generating the approximate k-nearest neighbor graph, and detailed description thereof will be omitted.

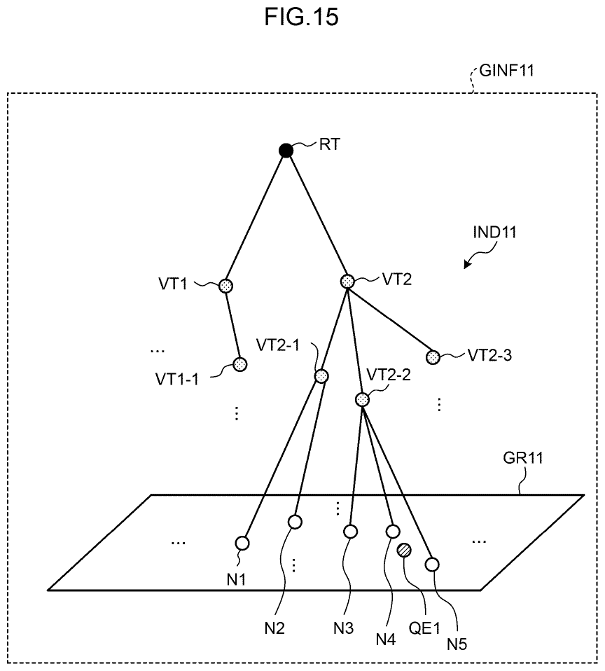

Furthermore, in the search processing, the information processing apparatus 100 may use starting point information GINF11 related to a tree structure (tree structure) as illustrated in FIG. 15 as the starting point information (starting point index). FIG. 15 is a diagram illustrating an example of starting point information used for information processing according to the embodiment. For example, the starting point information GINF11 is an index having a tree structure capable of reaching a node in the first graph GR1. Note that the starting point information such as the starting point information GINF11 may be generated by the information processing apparatus 100, or the information processing apparatus 100 may acquire the starting point information from another external apparatus such as the information providing apparatus 50.

In a case where the information processing apparatus 100 acquires the starting point information from another external device, the information processing apparatus 100 provides the graph to the other external device. Then, the information processing apparatus 100 acquires the starting point information generated by another external device that has received the graph from another external device. For example, in a case where the information processing apparatus 100 acquires the starting point information GINF11 from the information providing apparatus 50, the information processing apparatus 100 transmits the first graph GR1 to the information providing apparatus 50. Then, the information processing apparatus 100 acquires the starting point information GINF11 generated by the information providing apparatus 50 that has received the first graph GR1 from the information providing apparatus 50.

Furthermore, the information processing apparatus 100 may determine a starting point node using the start point information GINF11 as indicated in the starting point information GINF11 in FIG. 15. In the example of FIG. 15, the information processing apparatus 100 determines the starting point node corresponding to a query QE1 on the basis of the starting point information GINF11. The query QE1 may be a node corresponding to an object to be newly added, a target to be searched using the first graph GR1, or the like. That is, the information processing apparatus 100 determines the starting point node using the starting point information GINF11 at the time of graph generation or search.

Specifically, the information processing apparatus 100 determines the starting point node by using the starting point information GINF11 stored in the storage unit 120 (see FIG. 8). For example, the information processing apparatus 100 determines (specifies) a starting point node that is a candidate for the vicinity of the starting point information GINF11 by tracing the starting point information GINF11 downward from the upper side (route RT) on the basis of the query QE1. As a result, the information processing apparatus 100 can efficiently determine the starting point node corresponding to the search query (query QE1). For example, the information processing apparatus 100 can determine an appropriate starting point node corresponding to the query QE1 as the target node at a high speed.

Note that the information processing apparatus 100 is not limited to the above, and may use various starting point indexes. That is, the starting point information (starting point index) illustrated in the example of FIG. 15 is an example, and the information processing apparatus 100 may search the graph information using various starting point information. The information processing apparatus 100 may generate a starting point index used for determining a starting point node at the time of search. For example, the information processing apparatus 100 generates a search index (starting point information) for searching a high-dimensional vector at high speed. The high-dimensional vector referred to herein may be, for example, a vector of several hundred dimensions to several thousand dimensions, or a vector of more dimensions. Note that the above-described starting point index is an example, and the information processing apparatus 100 may generate a starting point index of any data structure as long as a query in a graph can be specified at a high speed.

### 2. Configuration of Information Processing System

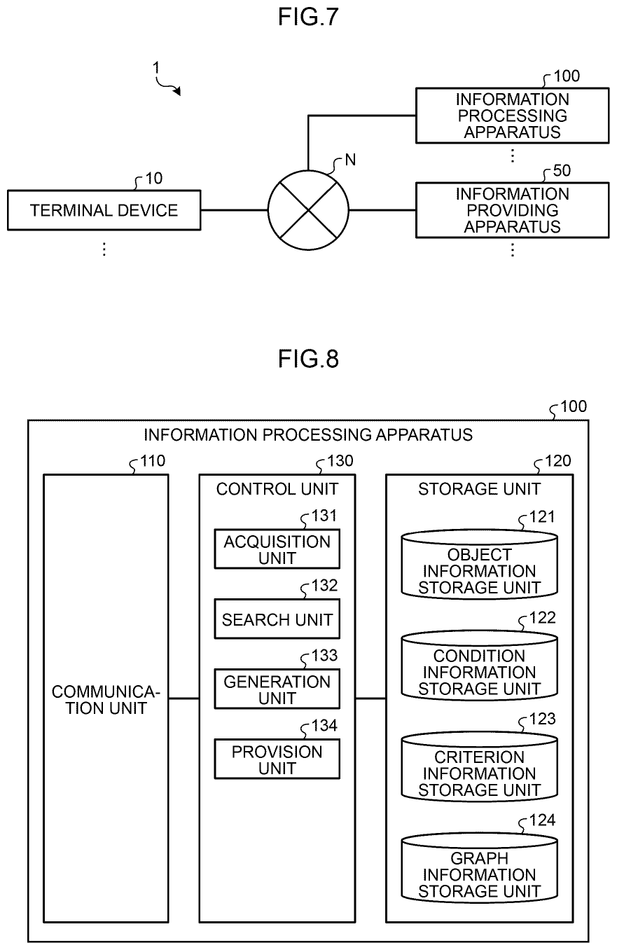

As illustrated in FIG. 7, an information processing system 1 includes a terminal device 10, an information providing apparatus 50, and an information processing apparatus 100. The terminal device 10, the information providing apparatus 50, and the information processing apparatus 100 are communicably connected in a wired or wireless manner via a predetermined network N. FIG. 7 is a diagram illustrating a configuration example of an information processing system according to the embodiment. Note that the information processing system 1 illustrated in FIG. 7 may include a plurality of terminal devices 10, a plurality of information providing apparatuses 50, and a plurality of information processing apparatuses 100.

The terminal device 10 is an information processing apparatus used by a user. The terminal device 10 receives various operations by the user. Note that, hereinafter, the terminal device 10 may be referred to as a user. That is, hereinafter, the user can be read as the terminal device 10. Note that the terminal device 10 described above is realized by, for example, a smartphone, a tablet terminal, a notebook personal computer (PC), a desktop PC, a mobile phone, a personal digital assistant (PDA), or the like.

The information providing apparatus 50 is an information processing apparatus that stores information for providing various types of information to a user or the like. For example, the information providing apparatus 50 stores an object ID based on character information or the like collected from various external devices such as a web server. For example, the information providing apparatus 50 is an information processing apparatus that provides an image retrieval service to a user or the like. For example, the information providing apparatus 50 stores each piece of information for providing the image retrieval service. For example, the information providing apparatus 50 provides vector information corresponding to an image as a target of the image retrieval service to the information processing apparatus 100. Furthermore, the information providing apparatus 50 transmits the query to the information processing apparatus 100, thereby receiving the object ID or the like indicating the image corresponding to the query from the information processing apparatus 100.

The information processing apparatus 100 is a computer that executes generation processing of generating information regarding a graph. The information processing apparatus 100 is a generation apparatus that generates the second graph using the first graph. The information processing apparatus 100 selects, as a target edge, one oriented edge that has not been selected as a processing target among the oriented edges having each of the plurality of nodes included in the first graph as a start point, and executes the shortcut edge deletion processing of setting the target edge selected for each of the plurality of nodes as a deletion determination target as a shortcut edge, thereby generating second information indicating the second graph obtained by deleting the oriented edge from the first graph.

The information processing apparatus 100 executes the shortcut edge deletion processing using the shortcut edge determination condition. In a case where a relationship among a first oriented edge with a first node as a start point and a second node as an end point, a second oriented edge with a first node as a start point and a third node different from the second node as an end point, and a third oriented edge with a third node as a start point and a second node as an end point among the edges included in the first graph satisfies a shortcut edge determination condition, the information processing apparatus 100 generates second information indicating a second graph in which the first oriented edge is deleted as a shortcut edge.

For example, upon receiving the query information (hereinafter, also simply referred to as a “query”) from the terminal device, the information processing apparatus 100 searches for a target similar to the query (vector information or the like) and provides a search result to the terminal device. Furthermore, for example, the data provided by the information processing apparatus 100 to the terminal device may be data itself such as image information, or may be information for referring to corresponding data such as a uniform resource locator (URL). Furthermore, the data of the query or the search target may be any type of data such as image, audio, or text data. In the present embodiment, a case where the information processing apparatus 100 searches for an image will be described as an example.

### 3. Configuration of Information Processing Apparatus

Next, a configuration of the information processing apparatus 100 according to the embodiment will be described with reference to FIG. 8. FIG. 8 is a diagram illustrating a configuration example of the information processing apparatus 100 according to the embodiment. As illustrated in FIG. 8, the information processing apparatus 100 includes a communication unit 110, a storage unit 120, and a control unit 130. Note that the information processing apparatus 100 may include an input unit (for example, a keyboard, a mouse, or the like) that receives various operations from an administrator or the like of the information processing apparatus 100, and a display unit (for example, a liquid crystal display or the like) for displaying various types of information.

### Communication Unit 110

The communication unit 110 is realized by, for example, a network interface card (NIC) or the like. Then, the communication unit 110 is connected to a network (for example, the network N in FIG. 7) in a wired or wireless manner, and transmits and receives information to and from the terminal device 10 and the information providing apparatus 50.

### Storage Unit 120

The storage unit 120 is realized by, for example, a semiconductor memory element such as a random access memory (RAM) or a flash memory, or a storage device such as a hard disk or an optical disk. As illustrated in FIG. 8, the storage unit 120 according to the embodiment includes an object information storage unit 121, a condition information storage unit 122, a criterion information storage unit 123, and a graph information storage unit 124.

### Object Information Storage Unit 121

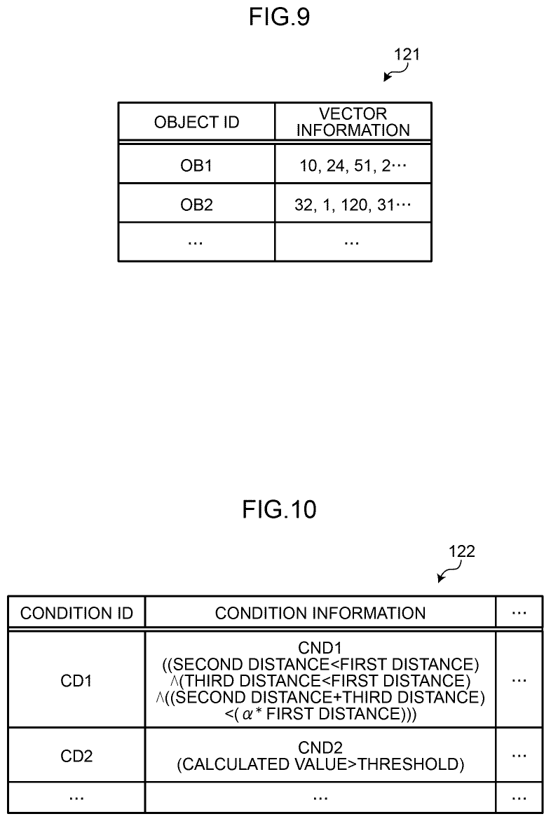

The object information storage unit 121 according to the embodiment stores various types of information regarding an object. For example, the object information storage unit 121 stores an object ID and vector data. FIG. 9 is a diagram illustrating an example of an object information storage unit according to the embodiment. The object information storage unit 121 illustrated in FIG. 9 includes items such as “object ID” and “vector information”.

The “object ID” indicates identification information for identifying an object. “Vector information” indicates vector information corresponding to the object identified by the object ID. That is, in the example of FIG. 9, vector data (vector information) corresponding to an object is registered in association with an object ID for identifying the object.

For example, in the example of FIG. 9, the object (target) identified by the ID “OB1” indicates that multidimensional vector information of “10, 24, 51, 2 . . . ” is associated.

Note that the object information storage unit 121 is not limited to the above, and may store various types of information depending on the purpose.

### Condition Information Storage Unit 122

The condition information storage unit 122 according to the embodiment stores various types of information related to a condition related to difficulty in search. FIG. 10 is a diagram illustrating an example of a condition information storage unit according to the embodiment. The condition information storage unit 122 illustrated in FIG. 10 includes items such as “condition ID” and “condition information”.

The “condition ID” indicates information for identifying a condition. The “condition information” stores information used for determination (determination) as to whether or not to delete an edge as a shortcut edge. Although FIG. 10 illustrates an example in which conceptual information such as “CND 1” is stored in “condition information”, actually, information indicating a specific condition such as a determination expression as illustrated in parentheses or a file path name indicating a storage location is stored.

The example of FIG. 10 indicates that the condition (condition CD1) identified by the condition ID “CD1” is a condition as illustrated in the condition information CND1. For example, the condition CD1 is that the second distance is smaller than the first distance, the third distance is smaller than the first distance, and a total value of the second distance and the third distance is smaller than a value obtained by multiplying the first distance by a predetermined coefficient α. That is, the condition CD1 is a condition for determining a target edge as a shortcut edge when all of a condition that the second distance is smaller than the first distance, a condition that the third distance is smaller than the first distance, and a condition that the total value of the second distance and the third distance is smaller than a value obtained by multiplying the first distance by a predetermined coefficient α are satisfied.

In addition, it is indicated that the condition (condition CD2) identified by the condition ID “CD2” is a condition as indicated in the condition information CND2. For example, the condition CD2 is that the calculated value calculated by the cosine theorem is larger than the threshold. That is, the condition CD2 is a condition for determining a target edge as a shortcut edge when a calculated value calculated based on the first distance, the second distance, the third distance, and the cosine theorem is larger than the threshold. For example, the condition CD2 is a condition for determining a target edge as a shortcut edge when a calculated value that is a cosine value of an angle formed by a second oriented edge corresponding to a second distance and a third oriented edge corresponding to a third distance is larger than the threshold. For example, the condition CD2 is a condition using a determination expression as indicated in the condition information CND2 in FIG. 1.

Note that the condition information storage unit 122 is not limited to the above, and may store various types of information depending on the purpose. For example, the condition information storage unit 122 may store information indicating which condition is to be used. For example, the condition information storage unit 122 may store information indicating designation of a condition to be used set by an administrator or the like of the information processing apparatus 100.

### Criterion Information Storage Unit 123

The criterion information storage unit 123 according to the embodiment stores various types of information related to criteria of various types of processing. For example, the criterion information storage unit 123 stores various types of information related to the criterion of the selection order of edges. FIG. 11 is a diagram illustrating an example of a criterion information storage unit according to the embodiment. The criterion information storage unit 123 illustrated in FIG. 11 includes items such as “criterion ID”, “target”, and “criterion content”. For example, the criterion information storage unit 123 stores various types of information regarding a criterion or a condition for executing various types of processing.

The “criterion ID” indicates information for identifying a criterion. The “target” indicates a target of the criterion of the selection order of the edge. The “criterion content” indicates specific content used as a corresponding criterion. Note that, in FIG. 11, an abstract reference sign such as “CINF11”, “CINF12”, or “CINF13” is illustrated as the “criterion content”, but it is assumed that the criterion content is information serving as a specific criterion, a conditional expression, or the like.

In FIG. 11, the criterion (criterion CR11) identified by the criterion ID “CR11” is a criterion of the selection order based on the distance. It is indicated that the target of the criterion CR11 is an edge, and its criterion content is “CINF11”. The criterion content CINF11 in FIG. 11 indicates that the selection order of the edges is determined in ascending order, that is, in order from the side where the length of the edge is shorter.

In FIG. 11, the criterion (criterion CR12) identified by the criterion ID “CR12” is a criterion of the selection order based on the distance. It is indicated that the target of the criterion CR12 is an edge, and its criterion content is “CINF12”. The criterion content CINF12 in FIG. 11 indicates that the selection order of the edges is determined in descending order, that is, in order from the side where the length of the edge is longer.

In FIG. 11, the criterion (criterion CR13) identified by the criterion ID “CR13” indicates that there is no specific target. It is indicated that the criterion content of the criterion CR13 is “CINF13”. The criterion content CINF13 in FIG. 11 indicates that the selection order of the edges is randomly determined.

Note that the criterion information storage unit 123 is not limited to the above, and may store various types of information depending on the purpose. For example, the criterion information storage unit 123 may store information indicating which criterion is used. For example, the criterion information storage unit 123 may store information indicating designation of a criterion to be used set by an administrator or the like of the information processing apparatus 100.

### Graph Information Storage Unit 124

The graph information storage unit 124 according to the embodiment stores various types of information related to a graph (graph data). For example, the graph information storage unit 124 stores graph information. FIG. 12 illustrates a case where the graph information storage unit 124 stores the first graph and the second information. For example, FIG. 12 illustrates a case where a graph (first graph) to be subjected to the shortcut edge deletion processing and “flag” which is second information corresponding to the first graph are stored as an example. For example, the graph information storage unit 124 stores graph data of a k-nearest neighbor graph as the first graph. For example, the graph information storage unit 124 stores graph data of an approximate k-nearest neighbor graph as the first graph. For example, the graph information storage unit 124 stores data of the first graph GR1 in FIG. 1.

Note that the information processing apparatus 100 may store the second graph separately from the first graph. In this case, the storage unit 120 may include a second graph information storage unit that stores the second graph, and the graph information storage unit 124 may not store the second information (information corresponding to the item “flag” in FIG. 12). The second graph information storage unit stores a graph (second graph) in which an edge (an edge whose flag is “0” in FIG. 12) determined to correspond to a shortcut edge is deleted from the first graph written in the graph information storage unit 124.

FIG. 12 is a diagram illustrating an example of a graph information storage unit according to the embodiment. The graph information storage unit 124 illustrated in FIG. 12 includes items such as “node ID”, “object ID”, and “oriented edge information”. Furthermore, the “oriented edge information” includes information such as an “edge ID”, a “reference destination”, and a “flag (second information)”.

The “node ID” indicates identification information for identifying each node (target) in the graph data. The “object ID” indicates identification information for identifying an object.

Furthermore, the “oriented edge information” indicates information regarding an edge connected to the corresponding node. In the example of FIG. 12, the “oriented edge information” indicates information regarding the output edge output from the corresponding node. In addition, “edge ID” indicates identification information for identifying an edge connecting nodes. Further, “reference destination” indicates information indicating a reference destination (node) connected by an edge. That is, in the example of FIG. 12, information for identifying an object (target) corresponding to a node and a reference destination (node) to which an oriented edge (output edge) from the node is connected are registered in association with a node ID for identifying the node.

The “flag (second information)” indicates the second information generated by the shortcut edge deletion processing. For example, the “flag (second information)” indicates whether the edge is valid or invalid in the second graph. For example, the “flag (second information)” indicates a case where “1” is assigned when the edge is valid in the second graph, and “0” is assigned when the edge is invalid.

In FIG. 12, the “flag (second information)” indicates whether or not the edge is determined to correspond to a shortcut edge by the shortcut edge deletion processing. For example, the “flag (second information)” is stored as “1” when it is determined that the edge does not correspond to the shortcut edge by the shortcut edge deletion processing, that is, when the edge is not deleted in the second graph and is also present in the second graph. The “flag (second information)” is stored as “0” when it is determined that the edge corresponds to the shortcut edge by the shortcut edge deletion processing, that is, when the edge is deleted in the second graph and is not present in the second graph.

In addition, the “flag (second information)” in FIG. 12 indicates a state in which either “1” indicating valid or “0” indicating invalid is assigned to all the edges in order to indicate a state after completion of generation of the second information. However, information indicating an unprocessed edge may be associated with an edge before being a target edge of the shortcut edge deletion processing. For example, in the “flag (second information)”, a flag (for example, any numerical value other than 0 and 1, Null, or the like) indicating that the edge is not yet processed may be assigned to an edge that is not yet a target edge of the shortcut edge deletion processing, that is, an unprocessed (unselected) edge. As a result, the information processing apparatus 100 can generate information for specifying the structure of the second graph from the second information, and can specify the processing status of the generation processing of the second information such as which edge has been processed.

The example of FIG. 12 indicates that the node (node N1) identified by the node ID “N1” corresponds to the object (target) identified by the object ID “OB1”. In addition, the node N1 indicates that the edge (edge E1) identified by the edge ID “E1” is connected to the node (node N2) identified by the node ID “N2”. That is, the example of FIG. 12 illustrates that the node N2 can be traced from the node N1 in the first graph by the edge E1. In addition, the flag of the edge E1 is “1”, indicating that the edge E1 is not deleted as a shortcut edge and is also present in the second graph. That is, the example of FIG. 12 shows that the node N2 can be traced from the node N1 by the edge E1 also in the second graph.

In addition, the node N1 indicates that the edge (edge E3) identified by the edge ID “E3” is connected to the node (node N3) identified by the node ID “N3”. That is, the example of FIG. 12 shows that the node N3 can be traced from the node N1 by the edge E3 in the first graph. In addition, the flag of the edge E3 is “0”, indicating that the edge E3 is deleted as a shortcut edge and is not present in the second graph. That is, in the example of FIG. 12, it is indicated that the node N1 cannot be directly traced to the node N3 by the edge E3 in the second graph.

Note that the graph information storage unit 124 is not limited to the above, and may store various types of information depending on the purpose. For example, the graph information storage unit 124 may store the length of the edge connecting the nodes (vectors). That is, the graph information storage unit 124 may store information indicating the distance between nodes (vectors). In addition, for example, the graph information storage unit 124 may store information indicating the number of input edges to each node.

In addition, the graph data may include a program module that uses a query as an input, searches nodes by tracing an edge in the graph data, and extracts and outputs a node similar to the query. That is, the graph data may be assumed to be used as a program module that performs search processing using a graph. For example, when vector data is input as a query, the graph data may be a program that extracts a node corresponding to vector data similar to the vector data from the graph and outputs the node. For example, the graph data may be data used as a program module for searching for a similar image corresponding to the query image. For example, the graph data causes the computer to extract and output nodes similar to the query in the graph based on the input query.

### Control Unit 130

Returning to the description of FIG. 8, the control unit 130 is a controller, and is implemented by, for example, a central processing unit (CPU), a micro processing unit (MPU), a graphics processing unit (GPU), or the like executing various programs (corresponding to an example of an information processing program) stored in a storage device inside the information processing apparatus 100 using a RAM as a work area. Furthermore, the control unit 130 is a controller, and is realized by, for example, an integrated circuit such as an application specific integrated circuit (ASIC) or a field programmable gate array (FPGA).

As illustrated in FIG. 8, the control unit 130 includes an acquisition unit 131, a search unit 132, a generation unit 133, and a provision unit 134, and implements or executes a function and an action of information processing described below. Note that the internal configuration of the control unit 130 is not limited to the configuration illustrated in FIG. 8, and may be another configuration as long as information processing to be described later is performed.

### Acquisition Unit 131

The acquisition unit 131 acquires various types of information. For example, the acquisition unit 131 acquires various types of information from the storage unit 120. For example, the acquisition unit 131 acquires various types of information from the object information storage unit 121, the condition information storage unit 122, the criterion information storage unit 123, the graph information storage unit 124, and the like. Furthermore, the acquisition unit 131 acquires various types of information from an external information processing apparatus.

The acquisition unit 131 acquires first graph information indicating a first graph in which a plurality of nodes corresponding to each of a plurality of objects to be searched are connected by edges. The acquisition unit 131 acquires condition information indicating a determination condition of a shortcut edge to be deleted in the graph.

The acquisition unit 131 acquires condition information indicating a determination condition of a shortcut edge based on the positional relationship among the first node, the second node, and the third node. The acquisition unit 131 acquires condition information indicating a determination condition of a shortcut edge based on a first distance between the first node and the second node, a second distance between the first node and the third node, and a third distance between the second node and the third node.

The acquisition unit 131 acquires condition information as a shortcut edge determination condition based on comparison between the second distance and the first distance, comparison between the third distance and the first distance, and comparison between a combination of the second distance and the third distance and the first distance. The acquisition unit 131 acquires condition information that sets, as a shortcut edge determination condition, a condition that the second distance is smaller than the first distance, the third distance is smaller than the first distance, and the total distance obtained by adding the second distance and the third distance is smaller than a value obtained by multiplying the first distance by a predetermined coefficient.

The acquisition unit 131 acquires condition information indicating a shortcut edge determination condition using the first distance, the second distance, the third distance, and the theorem regarding a triangle. The acquisition unit 131 acquires condition information indicating a shortcut edge determination condition using the first distance, the second distance, the third distance, and a function regarding a triangle. The acquisition unit 131 acquires condition information indicating a shortcut edge determination condition based on comparison between the calculated value and the threshold.

The acquisition unit 131 acquires condition information indicating a shortcut edge determination condition based on the first distance, the second distance, the third distance, and the cosine theorem. The acquisition unit 131 acquires condition information indicating a shortcut edge determination condition based on the first distance, the second distance, the third distance, and the cosine function. The acquisition unit 131 acquires condition information indicating a shortcut edge determination condition based on a threshold corresponding to the cosine value.

The acquisition unit 131 acquires condition information as a shortcut edge determination condition based on comparison between the second distance and the first distance, comparison between the third distance and the first distance, the first distance, the second distance, and the third distance, and the function related to a triangle. The acquisition unit 131 acquires condition information that sets, as a shortcut edge determination condition, a condition that the second distance is smaller than the first distance, the third distance is smaller than the first distance, and the calculated value calculated based on the first distance, the second distance, the third distance, and the cosine function is larger than the threshold.

The acquisition unit 131 acquires condition information as a shortcut edge determination condition based on comparison between the second distance and the first distance, comparison between the third distance and the first distance, the first distance, the second distance, and the third distance, and the theorem regarding a triangle. The acquisition unit 131 acquires condition information that sets, as a shortcut edge determination condition, a condition that the second distance is smaller than the first distance, the third distance is smaller than the first distance, and the calculated value calculated based on the first distance, the second distance, the third distance, and the cosine theorem is larger than the threshold.

The acquisition unit 131 acquires condition information indicating a shortcut edge determination condition based on a distance between the bypass node, the first node, and the second node. The acquisition unit 131 acquires condition information indicating a shortcut edge determination condition using a distance between the first node and the second node, a distance between the first node and the bypass node, a distance between the second node and the bypass node, and the theorem regarding a triangle. The acquisition unit 131 acquires condition information indicating a shortcut edge determination condition based on a distance between the first node and the second node, a distance between the first node and the bypass node, a distance between the second node and the bypass node, and the cosine theorem.

The acquisition unit 131 acquires the first graph information from the graph information storage unit 124. The acquisition unit 131 acquires a first graph that is a k-nearest neighbor graph. The acquisition unit 131 acquires a first graph that is an approximate k-nearest neighbor graph. For example, the information processing apparatus 100 acquires the first graph GR1 in FIG. 1. For example, the information processing apparatus 100 may acquire the first graph information such as the first graph GR1 from an external device such as the information providing apparatus 50.

For example, the acquisition unit 131 acquires information regarding the search query. For example, the acquisition unit 131 acquires a search query related to image search. For example, the acquisition unit 131 acquires a query from the terminal device 10 to be used. For example, the acquisition unit 131 acquires a query from the information providing apparatus 50 that has received the query from the terminal device 10 to be used.

### Search Unit 132

The search unit 132 searches for various types of information. The search unit 132 executes search processing using a graph. The search unit 132 functions as an extraction unit that extracts various types of information. The search unit 132 extracts various types of information. For example, the search unit 132 functions as a search unit that provides a search service related to an object. The search unit 132 searches various types of information. The search unit 132 searches for various types of information. For example, the search unit 132 searches for an object by searching graph data.

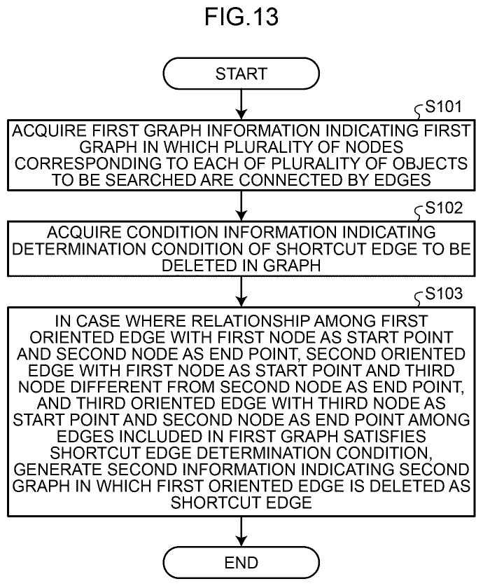

The search unit 132 executes search processing of searching for a graph in accordance with an instruction from the generation unit 133. For example, in a case where information indicating an object (node) to be processed is given, the search unit 132 searches a graph on the basis of a processing procedure as illustrated in FIG. 13, thereby extracting an object (node) similar to the object (node) to be a target. The search unit 132 extracts a neighboring object (neighboring node) of a target object (target node) through search processing of searching for a graph by setting one object (node) among a plurality of objects (nodes) as a target object (target node).

For example, the search unit 132 extracts various types of information from the object information storage unit 121, the condition information storage unit 122, the criterion information storage unit 123, the graph information storage unit 124, and the like. For example, the search unit 132 acquires the starting point information GINF11 from the storage unit 120. For example, the search unit 132 extracts various types of information on the basis of the information acquired by the acquisition unit 131.

The search unit 132 extracts a predetermined number (for example, the number of searches) of nodes from a plurality of nodes as neighboring nodes. The search unit 132 performs search processing of extracting neighboring nodes by searching a graph. The search unit 132 performs search processing of extracting a predetermined number of nodes as neighboring nodes on the basis of the relationship with the additional node among the plurality of nodes. The search unit 132 performs search processing of extracting a predetermined number of nodes as neighboring nodes on the basis of the distance between each of the plurality of nodes and the additional node.

For example, in a case where the query acquired by the acquisition unit 131 is acquired, the search unit 132 searches for an object similar to the query by searching graph data. For example, the search unit 132 extracts an object similar to the query by searching graph data. For example, the search unit 132 extracts an object similar to the query by searching graph data on the basis of a processing procedure as illustrated in FIG. 13.

The search unit 132 searches the graph to extract neighboring nodes. The search unit 132 extracts a predetermined number of neighboring nodes by searching the graph using the additional nodes as a query. The search unit 132 searches the graph by search processing as illustrated in FIG. 13 to extract neighboring nodes.

For example, the search unit 132 executes search processing using the generated graph GR11. For example, the search unit 132 executes search processing using the generated graph GR1.

### Generation Unit 133

The generation unit 133 executes various processing related to graph generation. The generation unit 133 executes generation processing for generating a graph. The generation unit 133 executes processing related to deletion of a shortcut. The generation unit 133 generates information indicating the graph from which the shortcut has been deleted. The generation unit 133 executes selection processing of selecting a node (object) as a processing target. The generation unit 133 instructs the search unit 132 to cause the search unit 132 to execute search processing, and acquires a search result from the search unit 132.

The generation unit 133 generates various types of information. For example, the generation unit 133 generates various types of information (data) from the information (data) stored in the storage unit 120. For example, the generation unit 133 generates various types of information from the object information storage unit 121, the condition information storage unit 122, the criterion information storage unit 123, the graph information storage unit 124, and the like.

For example, the generation unit 133 generates various types of information on the basis of the information acquired by the acquisition unit 131. The generation unit 133 generates various types of information by using the result of the search processing by the search unit 132.

The generation unit 133 generates the second information indicating the second graph in which the first oriented edge is deleted as the shortcut edge when the relationship among the first oriented edge with the first node as a start point and the second node as an end point, the second oriented edge with the first node as a start point and a third node different from the second node as an end point, and the third oriented edge with the third node as a start point and the second node as an end point among the edges included in the first graph satisfies the shortcut edge determination condition. When the positional relationship among the first node, the second node, and the third node satisfies the shortcut edge determination condition, the generation unit 133 generates second information indicating the second graph in which the first oriented edge is deleted as the shortcut edge.

The generation unit 133 executes shortcut edge deletion processing for a target edge on the basis of the first oriented edge that is a target edge, the second oriented edge with the first node that is a start point of the first oriented edge as a start point and the third node different from the second node that is an end point of the first oriented edge as an end point, and the third oriented edge with the third node as a start point and the second node as an end point. When the relationship among the first distance, the second distance, and the third distance satisfies the shortcut edge determination condition, the generation unit 133 generates second information indicating the second graph in which the first oriented edge is deleted as the shortcut edge.

When the comparison between the second distance and the first distance, the comparison between the third distance and the first distance, and the comparison between the combination of the second distance and the third distance and the first distance satisfy the shortcut edge determination condition, the generation unit 133 generates the second information indicating the second graph in which the first oriented edge is deleted as the shortcut edge. In a case where the second distance is smaller than the first distance, the third distance is smaller than the first distance, and the total distance obtained by adding the second distance and the third distance is smaller than a value obtained by multiplying the first distance by a predetermined coefficient, the generation unit 133 generates second information indicating the second graph in which the first oriented edge is deleted as a shortcut edge.

When the calculated value calculated based on the first distance, the second distance, the third distance, and the theorem satisfies the shortcut edge determination condition, the generation unit 133 generates second information indicating the second graph in which the first oriented edge is deleted as the shortcut edge. When the calculated value calculated based on the first distance, the second distance, the third distance, and the function satisfies the shortcut edge determination condition, the generation unit 133 generates the second information indicating the second graph in which the first oriented edge is deleted as the shortcut edge. When the calculated value is larger than the threshold, the generation unit 133 generates the second information indicating the second graph in which the first oriented edge is deleted as the shortcut edge.

When the calculated value calculated based on the first distance, the second distance, the third distance, and the cosine theorem satisfies the shortcut edge determination condition, the generation unit 133 generates second information indicating the second graph in which the first oriented edge is deleted as the shortcut edge. The generation unit 133 calculates a calculated value, which is a cosine value of an angle formed by the second oriented edge corresponding to the second distance and the third oriented edge corresponding to the third distance, using the cosine theorem, and when the calculated value satisfies the shortcut edge determination condition, generates second information indicating the second graph in which the first oriented edge is deleted as the shortcut edge.

When the calculated value calculated based on the first distance, the second distance, the third distance, and the cosine function satisfies the shortcut edge determination condition, the generation unit 133 generates second information indicating the second graph in which the first oriented edge is deleted as the shortcut edge. The generation unit 133 calculates, using the cosine function, a calculated value that is a cosine value of an angle formed by the second oriented edge corresponding to the second distance and the third oriented edge corresponding to the third distance, and when the calculated value satisfies the shortcut edge determination condition, generates second information indicating the second graph in which the first oriented edge is deleted as the shortcut edge. When the calculated value is larger than the threshold, the generation unit 133 generates the second information indicating the second graph in which the first oriented edge is deleted as the shortcut edge.

In a case where the comparison between the second distance and the first distance, the comparison between the third distance and the first distance, and the calculated value calculated based on the first distance, the second distance, the third distance, and the theorem satisfy the shortcut edge determination condition, the generation unit 133 generates the second information indicating the second graph in which the first oriented edge is deleted as the shortcut edge. In a case where the second distance is smaller than the first distance, the third distance is smaller than the first distance, and the calculated value calculated based on the first distance, the second distance, the third distance, and the cosine theorem is larger than the threshold, the generation unit 133 generates second information indicating the second graph in which the first oriented edge is deleted as a shortcut edge.

In a case where the comparison between the second distance and the first distance, the comparison between the third distance and the first distance, and the calculated value calculated based on the first distance, the second distance, the third distance, and the function satisfy the shortcut edge determination condition, the generation unit 133 generates the second information indicating the second graph in which the first oriented edge is deleted as the shortcut edge. In a case where the second distance is smaller than the first distance, the third distance is smaller than the first distance, and the calculated value calculated based on the first distance, the second distance, the third distance, and the cosine function is larger than the threshold, the generation unit 133 generates second information indicating the second graph in which the first oriented edge is deleted as a shortcut edge.

The generation unit 133 sets an oriented edge with a first node as a start point and a second node as an end point among edges included in the first graph as a target edge, and generates second information indicating a second graph in which the target edge is deleted as the shortcut edge in a case where a relationship among each of a plurality of bypass nodes including at least a third node connected with an oriented edge with the first node as a start point, and a fourth node serving as a start point of an oriented edge with the second node as an end point, the fourth node being a node reachable from the third node, the first node, and the second node satisfies the determination condition of the shortcut edge.

When the relationship among the distance between the first node and the second node, the distance between the first node and each of the plurality of bypass nodes, and the distance between the second node and each of the plurality of bypass nodes satisfies the shortcut edge determination condition, the generation unit 133 generates second information indicating the second graph in which the target edge is deleted as the shortcut edge. When the relationship among the distance between the first node and the second node, the distance between the first node and the third node, and the distance between the second node and the third node, and the relationship among the distance between the first node and the second node, the distance between the first node and the fourth node, and the distance between the second node and the fourth node satisfy the shortcut edge determination condition, the generation unit 133 generates second information indicating the second graph in which the target edge is deleted as the shortcut edge.

When the relationship among the distance between the first node and the second node, the distance between the first node and the fifth node, and the distance between the second node and the fifth node satisfies the shortcut edge determination condition, the generation unit 133 generates second information indicating the second graph in which the target edge is deleted as the shortcut edge. In a case where each of a plurality of calculated values calculated based on the distance between the first node and the second node, the distance between the first node and each of a plurality of bypass nodes, and the distance between the second node and each of the plurality of bypass nodes and the theorem satisfies the shortcut edge determination condition, the generation unit 133 generates second information indicating the second graph in which the target edge is deleted as the shortcut edge.

When each of the plurality of calculated values is larger than the threshold, the generation unit 133 generates the second information indicating the second graph in which the target edge is deleted as the shortcut edge. When each of a plurality of calculated values calculated based on the distance between the first node and the second node, the distance between the first node and each of the plurality of bypass nodes, the distance between the second node and each of the plurality of bypass nodes, and the cosine theorem satisfies the shortcut edge determination condition, the generation unit 133 generates second information indicating the second graph in which the target edge is deleted as the shortcut edge.

Using the cosine theorem, the generation unit 133 calculates each of a plurality of calculated values that is a cosine value of an angle formed by a side between the first node and each of the plurality of bypass nodes and a side between the second node and each of the plurality of bypass nodes, and when the calculated value satisfies a shortcut edge determination condition, generates second information indicating a second graph in which a target edge is deleted as a shortcut edge. When each of the plurality of calculated values is larger than the threshold, the generation unit 133 generates the second information indicating the second graph in which the target edge is deleted as the shortcut edge.

The generation unit 133 selects, as a target edge, one oriented edge that has not been selected as a processing target among the oriented edges with each of the plurality of nodes included in the first graph as a start point, and executes the shortcut edge deletion processing of setting the target edge selected for each of the plurality of nodes as a deletion determination target as a shortcut edge, thereby generating second information indicating the second graph in which the oriented edge is deleted from the first graph. The generation unit 133 sets the oriented edge selected as the processing target for executing the shortcut edge deletion processing as the already selected oriented edge, selects the target edge for each of the plurality of nodes, and repeatedly executes the shortcut edge deletion processing, thereby generating the second information.

The generation unit 133 generates the second information by repeatedly executing the shortcut edge deletion processing until there is no unselected oriented edge as a processing target for each of the plurality of nodes. The generation unit 133 selects the target edge for each of the plurality of nodes on the basis of the selection criteria for selecting the target edge and executes the shortcut edge deletion processing.

The generation unit 133 sets each of one nodes included in the first graph as a start point, selects the shortest oriented edge among the unselected oriented edges as processing targets, and executes the shortcut edge deletion processing. The generation unit 133 sets each of one nodes included in the first graph as a start point, selects the longest oriented edge among the unselected oriented edges as processing targets, and executes the shortcut edge deletion processing.

The generation unit 133 sets each of one nodes included in the first graph as a start point, randomly selects an oriented edge from among unselected oriented edges as processing targets, and executes the shortcut edge deletion processing. The generation unit 133 executes the shortcut edge deletion processing on the basis of the shortcut edge determination condition indicated by the condition information.

The generation unit 133 generates, as the second information, information for identifying an edge corresponding to a shortcut edge among the edges included in the first graph. The generation unit 133 generates, as the second information, a flag that is associated with each of the edges included in the first graph and indicates whether or not the edge is a shortcut edge. The generation unit 133 generates, as the second information, graph information in which the shortcut edge included in the first graph is deleted.

### Provision Unit 134

The provision unit 134 provides various types of information. For example, the provision unit 134 transmits various types of information to the terminal device 10 and the information providing apparatus 50. For example, the provision unit 134 provides the object ID corresponding to the query as a search result. For example, the provision unit 134 provides the object ID searched by the search unit 132 to the information providing apparatus 50. For example, the provision unit 134 provides the object ID extracted by the search unit 132 to the information providing apparatus 50. The provision unit 134 provides the object ID extracted by the search unit 132 to the information providing apparatus 50 as information indicating a vector corresponding to the query.

Furthermore, the provision unit 134 may provide the graph generated by the generation unit 133 to an external information processing apparatus. For example, the provision unit 134 may transmit the graph GR11 generated by the generation unit 133 to the information providing apparatus 50.

### 4. Flow of Information Processing

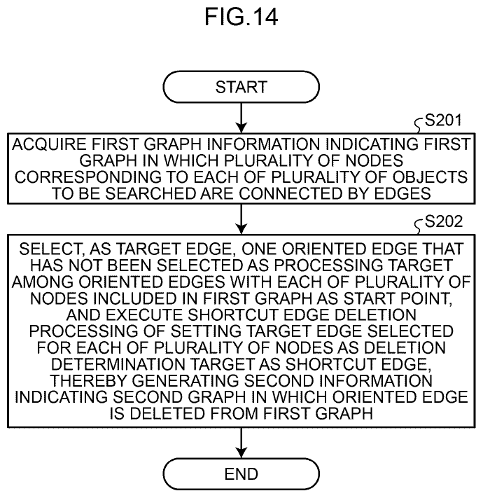

Next, a procedure of information processing by the information processing system 1 according to the embodiment will be described with reference to FIGS. 13 and 14. FIGS. 13 and 14 are flowcharts illustrating an example of information processing according to the embodiment.

First, FIG. 13 will be described. As illustrated in FIG. 13, the information processing apparatus 100 acquires first graph information indicating a first graph in which a plurality of nodes corresponding to each of a plurality of objects to be searched are connected by edges (step S101). For example, the information processing apparatus 100 acquires the first graph from the information providing apparatus 50.

Then, the information processing apparatus 100 acquires condition information indicating a determination condition of a shortcut edge to be deleted in the graph (step S102). For example, the information processing apparatus 100 acquires condition information from the information providing apparatus 50.

Then, in a case where the relationship among the first oriented edge with the first node as a start point and the second node as an end point, the second oriented edge with the first node as a start point and the third node different from the second node as an end point, and the third oriented edge with the third node as a start point and the second node as an end point among the edges included in the first graph satisfies the shortcut edge determination condition, the information processing apparatus 100 generates the second information indicating the second graph in which the first oriented edge is deleted as the shortcut edge (step S103). For example, the information processing apparatus 100 generates a flag indicating whether or not each edge is deleted in the first graph as the second information.

First, FIG. 14 will be described. As illustrated in FIG. 14, the information processing apparatus 100 acquires first graph information indicating a first graph in which a plurality of nodes corresponding to each of a plurality of objects to be searched are connected by edges (step S201). For example, the information processing apparatus 100 acquires the first graph from the information providing apparatus 50.

Then, the information processing apparatus 100 selects, as a target edge, one oriented edge that has not been selected as a processing target among the oriented edges with each of the plurality of nodes included in the first graph as a start point, and executes the shortcut edge deletion processing of setting the target edge selected for each of the plurality of nodes as a deletion determination target as a shortcut edge, thereby generating second information indicating the second graph in which the oriented edge is deleted from the first graph (step S202). For example, the information processing apparatus 100 generates a flag indicating whether or not each edge is deleted in the first graph as the second information.

### 5. Search Example

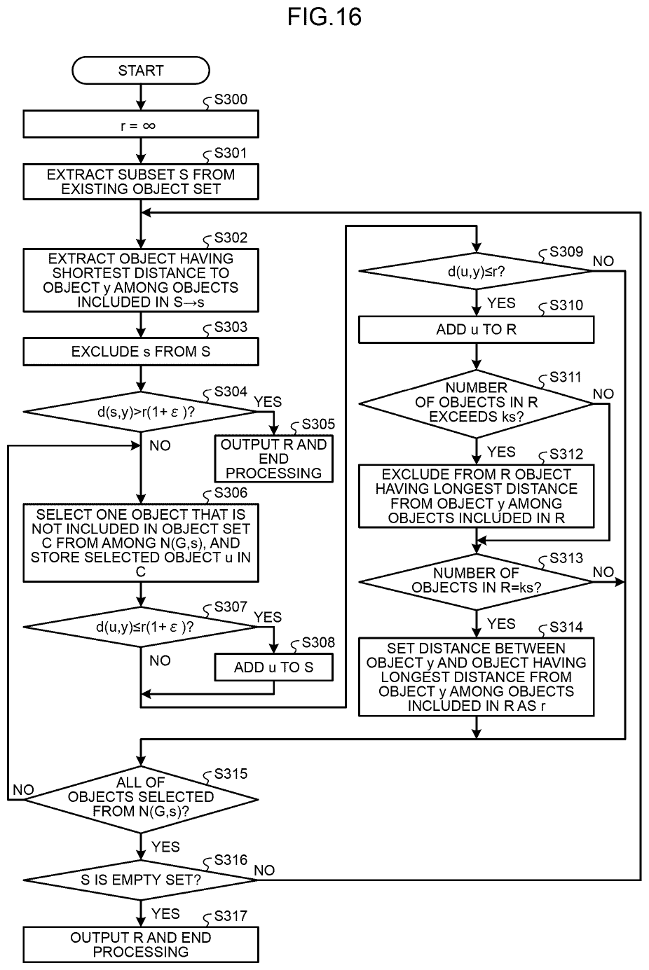

Here, an example of search using the above-described graph data will be described. Note that the search using the generated graph data is not limited to the following, and may be performed by various procedures. This point will be described with reference to FIG. 16 as an example. FIG. 16 is a flowchart illustrating an example of search processing using graph data. The search processing described below is performed by the search unit 132 of the information processing apparatus 100. In addition, the object referred to below may be read as a node. For example, the information processing apparatus 100 (for example, the search unit 132) performs search processing. The search query of the processing described below may be a target node, an object designated by the user, or the like.

Here, the neighboring object set N(G, y) is a set of neighboring objects associated by an edge assigned to the node y . . . “G” may be predetermined graph data (for example, the first graph GR1 and the like). For example, the information processing apparatus 100 executes k-nearest neighbor search processing.

For example, the information processing apparatus 100 sets the radius r of the hypersphere to ∞ (infinity) (step S300), and extracts the subset S from the existing object set (step S301). For example, the information processing apparatus 100 may extract an object (node) selected as the root node as the subset S. Furthermore, for example, the hypersphere is a virtual sphere indicating the search range. Note that the objects included in the object set S extracted in step S301 are simultaneously included also in the initial set of the object set R of the search results.

Next, the information processing apparatus 100 extracts an object having the shortest distance to the object y when the search query object is y among the objects included in the object set S, and sets the object as an object s (step S302). For example, in a case where only the object (node) selected as the root node is an element of S, the information processing apparatus 100 consequently extracts the root node as the object s. Next, the information processing apparatus 100 excludes the object s from the object set S (step S303).

Next, the information processing apparatus 100 determines whether or not the distance d(s, y) between the object s and the object y exceeds r(1+ε) (step S304). Here, ε is an extension element, and r(1+ε) is a value indicating a radius of a search range (Only nodes within this range are searched. It is possible to improve the accuracy by making it larger than the search range). In a case where the distance d(s, y) between the object s and the object y exceeds r(1+ε) (step S304: Yes), the information processing apparatus 100 outputs the object set R as a neighboring object set of the object y (step S305), and ends the processing.

In a case where the distance d(s, y) between the object s and the search query object y does not exceed r(1+ε) (step S304: No), the information processing apparatus 100 selects one object that is not included in an object set C from among objects that are elements of the neighboring object set N(G, s) of the object s, and stores a selected object u in the object set C (step S306). The object set C is provided for convenience in order to avoid duplicate search, and is set to an empty set at the start of processing.

Next, the information processing apparatus 100 determines whether or not the distance d(u, y) between the object u and the object y is equal to or less than r(1+ε) (step S307). In a case where the distance d(u, y) between the object u and the object y is equal to or less than r(1+ε) (step S307: Yes), the information processing apparatus 100 adds the object u to the object set S (step S308). Furthermore, in a case where the distance d(u, y) between the object u and the object y is not equal to or less than r(1+ε) (step S307: No), the information processing apparatus 100 performs the determination (processing) of step S309.

Next, the information processing apparatus 100 determines whether or not the distance d(u, y) between the object u and the object y is equal to or less than r (step S309). In a case where the distance d(u, y) between the object u and the object y exceeds r, the information processing apparatus 100 performs the determination (processing) of step S315. Furthermore, in a case where the distance d(u, y) between the object u and the object y is not equal to or less than r (step S309: No), the information processing apparatus 100 performs the determination (processing) of step S315.

In a case where the distance d(u, y) between the object u and the object y is equal to or less than r (step S309: Yes), the information processing apparatus 100 adds the object u to the object set R (step S310). Then, the information processing apparatus 100 determines whether or not the number of objects included in the object set R exceeds ks (step S311). The predetermined number ks is an arbitrarily determined natural number. For example, ks may be the number of candidates. For example, it may be any value such as ks=2. In a case where the number of objects included in the object set R does not exceed ks (step S311: No), the information processing apparatus 100 performs the determination (processing) in step S313.

In a case where the number of objects included in the object set R exceeds ks (step S311: Yes), the information processing apparatus 100 excludes an object having the longest distance (farthest) from the object y among the objects included in the object set R (step S312).

Next, the information processing apparatus 100 determines whether or not the number of objects included in the object set R coincides with ks (step S313). In a case where the number of objects included in the object set R does not coincide with ks (step S313: No), the information processing apparatus 100 performs determination (processing) in step S315. Furthermore, in a case where the number of objects included in the object set R coincides with ks (step S313: Yes), the information processing apparatus 100 sets a distance between an object y and an object having the longest (farthest) distance from the object y among the objects included in the object set R as a new r (step S314).

Then, the information processing apparatus 100 determines whether or not all the objects have been selected from the objects that are elements of the neighboring object set N(G, s) of the object s and stored in the object set C (step S315). In a case where all the objects have not been selected from the objects that are the elements of the neighboring object set N(G, s) of the object s and stored in the object set C (step S315: No), the information processing apparatus 100 returns to step S306 and repeats the processing.

In a case where all the objects have been selected from the objects that are the elements of the neighboring object set N(G, s) of the object s and stored in the object set C (step S315: Yes), the information processing apparatus 100 determines whether or not the object set S is an empty set (step S316). In a case where the object set S is not an empty set (step S316: No), the information processing apparatus 100 returns to step S302 and repeats the processing. Furthermore, in a case where the object set S is an empty set (step S316: Yes), the information processing apparatus 100 outputs the object set R and ends the processing (step S317). For example, the information processing apparatus 100 extracts objects (nodes) of the number of candidates included in the object set R as neighboring nodes corresponding to the target node (input object y). For example, the information processing apparatus 100 extracts an object (node) included in the object set R as a node group corresponding to the target node (input object y). Furthermore, for example, the information processing apparatus 100 may provide the objects (nodes) included in the object set R to the terminal device or the like that has performed the search as the search result corresponding to the search query (input object y).

### 6. Effects

As described above, the information processing apparatus (corresponding to the “information processing apparatus 100” in the embodiment) according to the embodiment includes the acquisition unit (corresponding to the “acquisition unit 131” in the embodiment) and the generation unit (corresponding to the “generation unit 133” in the embodiment). The acquisition unit acquires first graph information indicating a first graph in which a plurality of nodes corresponding to each of a plurality of objects to be searched are connected by edges, and condition information indicating a determination condition of a shortcut edge to be deleted in the graph. The generation unit sets an oriented edge with a first node as a start point and a second node as an end point among edges included in the first graph as a target edge, and generates second information indicating a second graph in which the target edge is deleted as the shortcut edge in a case where a relationship among each of bypass nodes including at least a third node connected with an oriented edge with the first node as a start point, and a fourth node serving as a start point of an oriented edge with the second node as an end point, the fourth node being a node reachable from the third node, the first node, and the second node satisfies the determination condition of the shortcut edge.

As described above, the information processing apparatus 100 according to the embodiment determines the shortcut edge on the basis of the relationship among the first node, the second node, and each of the bypass nodes, and generates the second information indicating the second graph from which the determined shortcut edge has been deleted, thereby appropriately generating the information indicating the other graph from which the edge has been deleted in the graph.

Furthermore, in the information processing apparatus 100 according to the embodiment, the acquisition unit acquires condition information indicating a shortcut edge determination condition based on the distance between the bypass node, the first node, and the second node. When the relationship among the distance between the first node and the second node, the distance between the first node and each of the bypass nodes, and the distance between the second node and each of the bypass nodes satisfies the shortcut edge determination condition, the generation unit generates second information indicating the second graph in which the target edge is deleted as the shortcut edge.

As a result, in a case where the relationship among the distance between the first node and the second node, the distance between the first node and each of the bypass nodes, and the distance between the second node and each of the bypass nodes satisfies the shortcut edge determination condition, the information processing apparatus 100 according to the embodiment can appropriately generate information indicating another graph in which the edge in the graph is deleted by deleting the target edge as the shortcut edge.

Furthermore, in the information processing apparatus 100 according to the embodiment, in a case where the relationship among the distance between the first node and the second node, the distance between the first node and the third node, and the distance between the second node and the third node, and the relationship among the distance between the first node and the second node, the distance between the first node and the fourth node, and the distance between the second node and the fourth node satisfy the shortcut edge determination condition, the generation unit generates the second information indicating the second graph in which the target edge is deleted as the shortcut edge.

As a result, the information processing apparatus 100 according to the embodiment determines whether the condition is satisfied for each bypass node such as the fourth node and the fifth node, and can appropriately generate information indicating another graph in which an edge in the graph is deleted.

Furthermore, in the information processing apparatus 100 according to the embodiment, in a case where the fourth node is reachable from the third node via one or more nodes, the bypass node includes a fifth node which is a node on a route from the third node to the fourth node. When the relationship among the distance between the first node and the second node, the distance between the first node and the fifth node, and the distance between the second node and the fifth node satisfies the shortcut edge determination condition, the generation unit generates second information indicating the second graph in which the target edge is deleted as the shortcut edge.

As a result, even in a case where there are three or more bypass nodes, the information processing apparatus 100 according to the embodiment can appropriately generate information indicating another graph in which an edge in the graph has been deleted.

Furthermore, in the information processing apparatus 100 according to the embodiment, the acquisition unit acquires condition information indicating a shortcut edge determination condition using a distance between the first node and the second node, a distance between the first node and the bypass node, a distance between the second node and the bypass node, and the theorem regarding a triangle. When each of the calculated values calculated based on the distance between the first node and the second node, the distance between the first node and each of the bypass nodes, the distance between the second node and each of the bypass nodes, and the theorem satisfies the shortcut edge determination condition, the generation unit generates second information indicating the second graph in which the target edge is deleted as the shortcut edge.

As a result, when each of the calculated values calculated based on the distance between the first node and the second node, the distance between the first node and each of the bypass nodes, the distance between the second node and each of the bypass nodes, and the theorem satisfies the shortcut edge determination condition, the information processing apparatus 100 according to the embodiment can appropriately generate information indicating another graph in which the edge in the graph has been deleted by deleting the target edge as the shortcut edge.

Furthermore, in the information processing apparatus 100 according to the embodiment, the acquisition unit acquires condition information indicating a shortcut edge determination condition based on comparison between a calculated value and a threshold. When each of the calculated values is larger than the threshold, the generation unit generates second information indicating the second graph in which the target edge is deleted as the shortcut edge.

As a result, in a case where each of the calculated values is larger than the threshold, the information processing apparatus 100 according to the embodiment can appropriately generate the information indicating another graph in which the edge in the graph has been deleted by deleting the target edge as the shortcut edge.

Furthermore, in the information processing apparatus 100 according to the embodiment, the acquisition unit acquires condition information indicating a shortcut edge determination condition based on the distance between the first node and the second node, the distance between the first node and the bypass node, the distance between the second node and the bypass node, and the cosine theorem. When each of the calculated values calculated based on the distance between the first node and the second node, the distance between the first node and each of the bypass nodes, the distance between the second node and each of the bypass nodes, and the cosine theorem satisfies the shortcut edge determination condition, the generation unit generates second information indicating the second graph in which the target edge is deleted as the shortcut edge.

As a result, in a case where each of the calculated values calculated based on the distance between the first node and the second node, the distance between the first node and each of the bypass nodes, the distance between the second node and each of the bypass nodes, and the cosine theorem satisfies the shortcut edge determination condition, the information processing apparatus 100 according to the embodiment can appropriately generate information indicating another graph in which the edge in the graph has been deleted by deleting the target edge as the shortcut edge.

Furthermore, in the information processing apparatus 100 according to the embodiment, the generation unit uses the cosine theorem to calculate each of the calculated values that is a cosine value of an angle formed by a side between the first node and each of the bypass nodes and a side between the second node and each of the bypass nodes, and in a case where the calculated value satisfies the shortcut edge determination condition, the generation unit generates second information indicating the second graph in which the target edge has been deleted as the shortcut edge.

As a result, in a case where each of the calculated values that is a cosine value of the angle formed by the side between the first node and each of the bypass nodes and the side between the second node and each of the bypass nodes, satisfies the shortcut edge determination condition, the information processing apparatus 100 according to the embodiment can appropriately generate information indicating another graph in which the edge in the graph has been deleted by deleting the target edge as the shortcut edge.

Furthermore, in the information processing apparatus 100 according to the embodiment, the acquisition unit acquires condition information indicating a shortcut edge determination condition based on the threshold corresponding to the cosine value. When each of the calculated values is larger than the threshold, the generation unit generates second information indicating the second graph in which the target edge is deleted as the shortcut edge.

As a result, in a case where each of the calculated values is larger than the threshold corresponding to the cosine value, the information processing apparatus 100 according to the embodiment can appropriately generate the information indicating another graph in which the edge in the graph has been deleted by deleting the target edge as the shortcut edge.

Furthermore, in the information processing apparatus 100 according to the embodiment, the generation unit generates, as the second information, information for identifying an edge corresponding to a shortcut edge among the edges included in the first graph.

As a result, the information processing apparatus 100 according to the embodiment generates the information for identifying the edge corresponding to the shortcut edge among the edges included in the first graph as the second information, thereby appropriately generating the information indicating another graph in which the edge in the graph has been deleted.

Furthermore, in the information processing apparatus 100 according to the embodiment, the generation unit generates, as the second information, a flag that is associated with each of the edges included in the first graph and indicates whether or not the edge is a shortcut edge.

As a result, the information processing apparatus 100 according to the embodiment generates the flag that is associated with each of the edges included in the first graph and indicates whether or not the edge is a shortcut edge as the second information, thereby appropriately generating the information indicating another graph in which the edge in the graph has been deleted.

Furthermore, in the information processing apparatus 100 according to the embodiment, the generation unit generates graph information in which a shortcut edge included in the first graph is deleted as the second information.

As a result, the information processing apparatus 100 according to the embodiment generates the graph information in which the shortcut edge included in the first graph is deleted as the second information, thereby appropriately generating the information indicating another graph in which the edge in the graph is deleted.

### 7. Hardware Configuration

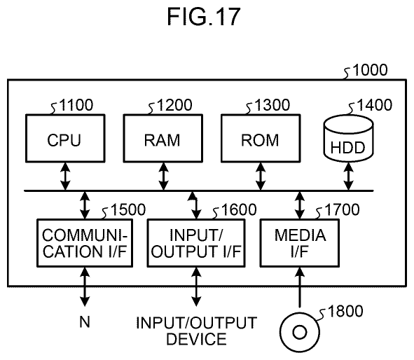

The information processing apparatus 100 according to the above-described embodiment is realized by a computer 1000 having a configuration as illustrated in FIG. 17, for example. FIG. 17 is a hardware configuration diagram illustrating an example of a computer that implements the functions of the information processing apparatus. The computer 1000 includes a CPU 1100, a RAM 1200, a read only memory (ROM) 1300, a hard disk drive (HDD) 1400, a communication interface (I/F) 1500, an input/output interface (I/F) 1600, and a media interface (I/F) 1700.

The CPU 1100 operates on the basis of a program stored in the ROM 1300 or the HDD 1400, and controls each unit. The ROM 1300 stores a boot program executed by the CPU 1100 when the computer 1000 is activated, a program depending on hardware of the computer 1000, and the like.

The HDD 1400 stores a program executed by the CPU 1100, data used by the program, and the like. The communication interface 1500 receives data from another device via a network N, transmits the data to the CPU 1100, and transmits data generated by the CPU 1100 to another device via the network N.

The CPU 1100 controls an output device such as a display or a printer and an input device such as a keyboard or a mouse via the input/output interface 1600. The CPU 1100 acquires data from the input device via the input/output interface 1600. In addition, the CPU 1100 outputs the generated data to the output device via the input/output interface 1600.

The media interface 1700 reads a program or data stored in a recording medium 1800 and provides the program or data to the CPU 1100 via the RAM 1200. The CPU 1100 loads the program from the recording medium 1800 onto the RAM 1200 via the media interface 1700, and executes the loaded program. The recording medium 1800 is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 100 according to the embodiment, the CPU 1100 of the computer 1000 implements the function of the control unit 130 by executing a program loaded onto the RAM 1200. The CPU 1100 of the computer 1000 reads and executes these programs from the recording medium 1800, but as another example, these programs may be acquired from another device via the network N.

Although some of the embodiments of the present application have been described in detail with reference to the drawings, these are merely examples, and the present invention can be implemented in other forms subjected to various modifications and improvements based on the knowledge of those skilled in the art, including the aspects described in the disclosure of the invention.

### 8. Others

Among the processing described in the above embodiments, all or a part of the processing described as being automatically performed can be manually performed, or all or a part of the processing described as being manually performed can be automatically performed by a known method. In addition, the processing procedure, specific name, and information including various data and parameters illustrated in the above document and the drawings can be arbitrarily changed unless otherwise specified. For example, the various types of information illustrated in each figure are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an arbitrary unit according to various loads, usage conditions, and the like.

In addition, each processing described in each embodiment described above can be appropriately combined within a range in which processing contents do not contradict each other.

In addition, the “part (section, module, unit)” described above can be read as “means”, “circuit”, or the like. For example, the acquisition unit can be replaced with acquisition means or an acquisition circuit.

According to one aspect of the embodiment, it is possible to appropriately generate information indicating another graph from which an edge has been deleted in the graph.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus, comprising:
an acquisition unit that acquires first graph information indicating a first graph in which a plurality of nodes corresponding to each of a plurality of objects to be searched are connected by edges and condition information indicating a determination condition of a shortcut edge to be deleted in a graph; and
a generation unit that sets an oriented edge with a first node as a start point and a second node as an end point among edges included in the first graph as a target edge, and generates second information indicating a second graph in which the target edge is deleted as the shortcut edge in a case where a relationship among each of bypass nodes including at least a third node connected with an oriented edge with the first node as a start point, and a fourth node serving as a start point of an oriented edge with the second node as an end point, the fourth node being a node reachable from the third node, the first node, and the second node satisfies the determination condition of the shortcut edge.

2. The information processing apparatus according to claim 1, wherein
the acquisition unit
acquires the condition information indicating a determination condition of the shortcut edge based on a distance between the bypass node, the first node, and the second node, and
the generation unit
generates the second information indicating the second graph in which the target edge is deleted as the shortcut edge in a case where a relationship among a distance between the first node and the second node, a distance between the first node and each of the bypass nodes, and a distance between the second node and each of the bypass nodes satisfies a determination condition of the shortcut edge.

3. The information processing apparatus according to claim 2, wherein
the generation unit
generates the second information indicating the second graph in which the target edge is deleted as the shortcut edge in a case where a relationship among a distance between the first node and the second node, a distance between the first node and the third node, and a distance between the second node and the third node, and a relationship among a distance between the first node and the second node, a distance between the first node and the fourth node, and a distance between the second node and the fourth node satisfy a determination condition of the shortcut edge.

4. The information processing apparatus according to claim 3, wherein
the bypass node includes a fifth node that is a node on a path from the third node to the fourth node when the bypass node is reachable from the third node to the fourth node via one or more nodes, and
the generation unit
generates the second information indicating the second graph in which the target edge is deleted as the shortcut edge in a case where a relationship among a distance between the first node and the second node, a distance between the first node and the fifth node, and a distance between the second node and the fifth node satisfies a determination condition of the shortcut edge.

5. The information processing apparatus according to claim 2, wherein
the acquisition unit
acquires the condition information indicating a determination condition of the shortcut edge using a distance between the first node and the second node, a distance between the first node and the bypass node, a distance between the second node and the bypass node, and a theorem regarding a triangle, and
the generation unit
generates the second information indicating the second graph in which the target edge is deleted as the shortcut edge in a case where each of calculated values calculated based on a distance between the first node and the second node, a distance between the first node and each of the bypass nodes, a distance between the second node and each of the bypass nodes, and the theorem satisfies a determination condition of the shortcut edge.

6. The information processing apparatus according to claim 5, wherein
the acquisition unit
acquires the condition information indicating a determination condition of the shortcut edge based on comparison between the calculated value and a threshold, and
the generation unit
generates the second information indicating the second graph in which the target edge is deleted as the shortcut edge in a case where each of the calculated values is larger than the threshold.

7. The information processing apparatus according to claim 5, wherein
the acquisition unit
acquires the condition information indicating a determination condition of the shortcut edge based on a distance between the first node and the second node, a distance between the first node and the bypass node, a distance between the second node and the bypass node, and a cosine theorem, and
the generation unit
generates the second information indicating the second graph in which the target edge is deleted as the shortcut edge in a case where each of the calculated values calculated based on the distance between the first node and the second node, the distance between the first node and each of the bypass nodes, the distance between the second node and each of the bypass nodes, and the cosine theorem satisfies a determination condition of the shortcut edge.

8. The information processing apparatus according to claim 7, wherein
the generation unit
uses the cosine theorem to calculate each of the calculated values that is a cosine value of an angle formed by a side between the first node and each of the bypass nodes and a side between the second node and each of the bypass nodes, and generates the second information indicating the second graph in which the target edge is deleted as the shortcut edge in a case where the calculated value satisfies a determination condition of the shortcut edge.

9. The information processing apparatus according to claim 8, wherein
the acquisition unit
acquires the condition information indicating a determination condition of the shortcut edge based on a threshold corresponding to the cosine value, and
the generation unit
generates the second information indicating the second graph in which the target edge is deleted as the shortcut edge in a case where each of the calculated values is larger than the threshold.

10. The information processing apparatus according to claim 1, wherein
the generation unit
generates, as the second information, information for identifying an edge corresponding to the shortcut edge among the edges included in the first graph.

11. The information processing apparatus according to claim 1, wherein
the generation unit
generates, as the second information, a flag that is associated with each of the edges included in the first graph and indicates whether or not the edge is the shortcut edge.

12. The information processing apparatus according to claim 1, wherein
the generation unit
generates, as the second information, graph information in which the shortcut edge included in the first graph is deleted.

13. An information processing method executed by a computer, the method comprising:
an acquisition step of acquiring first graph information indicating a first graph in which a plurality of nodes corresponding to each of a plurality of objects to be searched are connected by edges and condition information indicating a determination condition of a shortcut edge to be deleted in the graph; and
a generation step of setting an oriented edge with a first node as a start point and a second node as an end point among edges included in the first graph as a target edge, and generating second information indicating a second graph in which the target edge is deleted as the shortcut edge in a case where a relationship among each of bypass nodes including at least a third node connected with an oriented edge with the first node as a start point, and a fourth node serving as a start point of an oriented edge with the second node as an end point, the fourth node being a node reachable from the third node, the first node, and the second node satisfies the determination condition of the shortcut edge.

14. A non-transitory computer-readable recording medium having stored therein an information processing program causing a computer to execute:
an acquisition procedure of acquiring first graph information indicating a first graph in which a plurality of nodes corresponding to each of a plurality of objects to be searched are connected by an edge and condition information indicating a determination condition of a shortcut edge to be deleted in the graph; and
a generation procedure of setting an oriented edge with a first node as a start point and a second node as an end point among edges included in the first graph as a target edge, and generating second information indicating a second graph in which the target edge is deleted as the shortcut edge in a case where a relationship among each of bypass nodes including at least a third node connected with an oriented edge with the first node as a start point, and a fourth node serving as a start point of an oriented edge with the second node as an end point, the fourth node being a node reachable from the third node, the first node, and the second node satisfies the determination condition of the shortcut edge.
